(19) United States
(12) Patent Application Publication
(10) Pub. No.: US 2007/0271166 A1
(43) Pub. Date: Nov. 22, 2007

(54) SYSTEM AND METHOD FOR CREATING AN INVESTMENT POLICY STATEMENT

(75) Inventors: Norman M. Boone, Oakland, CA (US); Linda S. Lubitz Boone, Miami, FL (US); Michael C. Eldred, Grandville, MI (US); Chad A. Gilbert, Kentwood, MI (US)

Correspondence Address: WARNER NORCROSS & JUDD LLP, 900 FIFTH THIRD CENTER, 111 LYON STREET, N.W., GRAND RAPIDS, MI, 49503-2487, US

(73) Assignee: BLIPS PARTNERS, LLC, Miami, FL (US)

(21) Appl. No.: 11/736,391

(22) Filed: Apr. 17, 2007

Related U.S. Application Data
(60) Provisional application No. 60/744,980, filed on Apr. 17, 2006.

(51) Int. Cl. G06Q 40/00

(52) U.S. Cl. 705/36 R

(57) ABSTRACT

A system and method for the creation of an Investment Policy Statement (“IPS”). A user may create or modify paragraphs and sections of an IPS template with response dependent fields. Asset allocation models are available from the system, or a user can create an unlimited number of custom asset allocation models. An IPS is generated for a client by completing an IPS questionnaire. Based upon answers to the IPS questionnaire, response dependent fields are completed and various response dependent fields are shown or hidden in the IPS.

### BACKGROUND OF THE INVENTION

An IPS (“Investment Policy Statement”) documents the agreements between a client and investment manager with regards to the investment philosophy, goals and investment management procedures to be adhered to while the funds are being managed. The IPS serves as the basis for future investment decisions made by an investment manager on behalf of an investing individual or institution. Among other things, an IPS is a directive from a client to the investment manager stating how the client's assets are to be managed.

An IPS has several advantages. An IPS causes an investor and the advisor to be disciplined and systematic in decision making. It clarifies the objectives and expectations both for the investor and the advisor. It provides an objective means to gauge whether the investor and the advisor are complying with investment requirements established by the investor. The IPS communicates to advisors, fiduciaries, and beneficiaries how the investor desires the investments to be managed. A full description of the benefits of an IPS as well as the creation of an IPS may be found within “Creating an Investment Policy Statement” by Norman M. Boone and Linda S. Lubitz, and published by AdvisorPress (2004), ISBM 0-9753448-0-3, which is hereby incorporated by reference.

Practically speaking, all investors should have an IPS and almost all financial advisors would benefit from having an IPS for each client relationship. However, most investors do not have an IPS and most financial advisors do not have a specific IPS for each of their clients. If financial advisors have an IPS at all, it is often a single, generic IPS that they use with all clients. The reasons for not creating a tailored IPS for each investor are varied. The collection of information from the investor can be time consuming. Current statistical information such as the expected return on a particular class of investment can be difficult to find and incorporate into an IPS. Also, the definition of an investor's particular goals may be difficult to ascertain, and even more difficult to maintain. Creating an IPS takes more time at the front end of a client-advisor relationship, but may ultimately provide other benefits later.

Several pieces of legislation, notably the Employee Retirement Income and Security Act (ERISA) of 1974 and the state-adopted Uniform Prudent Investor Act (UPIA) require an IPS when one or more people are making investment decisions on behalf of another person. In a significant number of instances, personal trusts, institutional trusts and employer-sponsored retirement plans may be violating a rule of law by not having an established investment policy statement.

Thus, there exists a need for an improved system and method for creating an IPS.

### SUMMARY OF THE INVENTION

The aforementioned needs are met by an Investment Policy Statement (“IPS”) system including software that allows a user to configure the system to create and maintain an IPS for one or more clients.

A process for creating an IPS, from a user's perspective, generally includes the following steps: starting an IPS; completing a questionnaire, choosing an asset allocation model, downloading and printing the IPS, and if necessary, modifying the IPS.

A process for creating an IPS from the system's perspective generally includes the following steps: receiving an IPS template selection, communicating to the client an IPS questionnaire tailored to the IPS template selection, receiving client responses to the IPS questionnaire, receiving an asset allocation model selection, generating an IPS based on the client questionnaire responses and the asset allocation model selection, and, if necessary, receiving revisions to the IPS based on client feedback.

For a user to begin preparing an IPS, an IPS name, date, IPS Type, version, and IPS template are chosen and sent to the system. The template may be a pre-programmed template, a modification of an existing template, or a new template generated from scratch. An IPS template includes, among other things, response dependent fields. Response dependent fields are fields that are at least partially dependent on responses to a client questionnaire that may be incorporated into sections or paragraphs such that when the fields are filled the paragraphs or sections are completed. Additionally or alternatively, entire paragraphs or sections may be response dependent fields, which enables paragraphs or sections to be shown or hidden in the IPS. Blank response dependent fields may be collapsible to remove unnecessary white space in the IPS.

With the IPS template selected, a client questionnaire is determined. The questionnaire is tailored to gauge the client's investment needs and investment goals. The questionnaire may include various questions about the client, the client's financial position, the client's views on investment, the client's financial objectives, and other investment related considerations. Different client types may have modified versions of the questionnaire or modified versions of the IPS template.

The user may also choose an asset allocation model. An asset allocation model is a suggested allocation of investments between different asset classes. Similar to managing other sections of the IPS, a user can choose a pre-defined asset allocation model, modify an existing asset allocation model, or create a new asset allocation model from scratch.

The client's responses to the questionnaire are used to create a detailed client profile. After some processing, the IPS template, client profile and the selected asset allocation model are integrated into an IPS that may be downloaded and printed. The system generates an IPS by filling response dependent fields and incorporating appropriate sections and paragraphs based on the client's answers to the questionnaire and selection of the asset allocation model. The resulting IPS is tailored to the specific needs and circumstances of the client, outlining the client's objectives and the planned method to attain those objectives.

The resulting IPS may be modified if necessary. The client may review the IPS in order to provide feedback and revisions to the IPS may be made based on the client's feedback.

There are various data models that support the system. One embodiment of the system has approximately thirty unique asset classes, each with its own unique data points. Each asset class has its own unique data series, collected about its performance over a different period of time. Primary investment data consists of investment returns and investment risk, as measured by standard deviation. Each asset class has a statistical correlation to every other asset class. The extent to which one asset class behaves similarly to or differently from another asset class determines their correlation pairing. The combination of multiple individual correlation pairings is known as a correlation matrix.

Every asset allocation model includes at least one asset class by itself or organized in a unique combination with other asset classes. By utilizing the risk and return data and the particular proportional weighting of each of the asset classes making up a particular asset allocation model, and in further consideration of the correlation matrix of those specific included asset classes, the system may determine an expected rate of risk and return level for the portfolio as a whole. If the mix of asset classes within the asset allocation model changes, then the calculated portfolio risk and return data will also change.

The present invention provides a simple, efficient, easy to use system and process for creating, using and maintaining multiple IPSs.

These and other objects, advantages and features of the invention will be more readily understood and appreciated by reference to the detailed description of the drawings.

### BRIEF DESCRIPTION OF THE DRAWINGS

FIG. 1A shows a flow chart of the process to create an IPS from a user's perspective;

FIG. 1B shows a flow chart of the process to create an IPS from the system's perspective;

FIG. 2 shows a block diagram of the system;

FIG. 3 shows a menu interface for navigating the system;

FIG. 4 shows an interface for creating a new template;

FIG. 5 shows an IPS template management interface;

FIG. 6 shows a template section-paragraph management interface;

FIG. 7 shows an edit template section interface;

FIG. 8 shows an edit template paragraph interface;

FIG. 9 shows a paragraph finder;

FIG. 10 shows an edit response dependency interface;

FIG. 11 shows a manage header/footer layout interface;

FIG. 12 shows an asset allocation model;

FIG. 13 shows an asset allocation model management interface;

FIG. 14 shows a new asset allocation model interface;

FIG. 15 shows an asset allocation model selector interface;

FIG. 16 shows an asset allocation model management interface;

FIG. 17 shows an edit asset allocation model interface;

FIG. 18 shows an asset class management interface;

FIG. 19 shows an asset class selector interface;

FIG. 20 shows an asset class management interface;

FIG. 21 shows an interface for adding a new user;

FIG. 22 shows a client interface;

FIG. 23 shows an IPS creation interface;

FIG. 24 shows an economic assumption questionnaire;

FIG. 25 shows an investment objective questionnaire;

FIG. 26 shows a time horizon questionnaire;

FIG. 27 shows a tax consideration questionnaire;

FIG. 28A shows a portion of a risk tolerance questionnaire;

FIG. 28B shows another portion of the risk tolerance questionnaire of FIG. 28A;

FIG. 28C shows another portion of the risk tolerance questionnaire of FIG. 28A;

FIG. 29 shows an investment policy items questionnaire;

FIG. 30 shows an advisor's philosophy and procedures questionnaire;

FIG. 31A shows an asset allocation investment constraints questionnaire;

FIG. 31B shows a portion of a benchmark questionnaire;

FIG. 31C shows another portion of the benchmark questionnaire;

FIG. 32 shows an IPS print interface;

FIGS. 33-53 show a completed IPS, prepared by the system;

FIG. 54 shows a general IPS template data model;

FIG. 55 shows a general IPS asset allocation data model;

FIG. 56 shows a general questionnaire data model;

FIG. 57A shows a portion of a detailed IPS Template data model;

FIG. 57B shows another portion of the detailed IPS template data model of FIG. 57A;

FIG. 58A shows a portion of a detailed questionnaire data model;

FIG. 58B shows another portion of the detailed questionnaire data model of FIG. 58A;

FIG. 59A shows a portion of a detailed IPS asset allocation data model;

FIG. 59B shows another portion of the detailed IPS template data model of FIG. 59A.

### DETAILED DESCRIPTION OF THE DRAWINGS

I. Overview

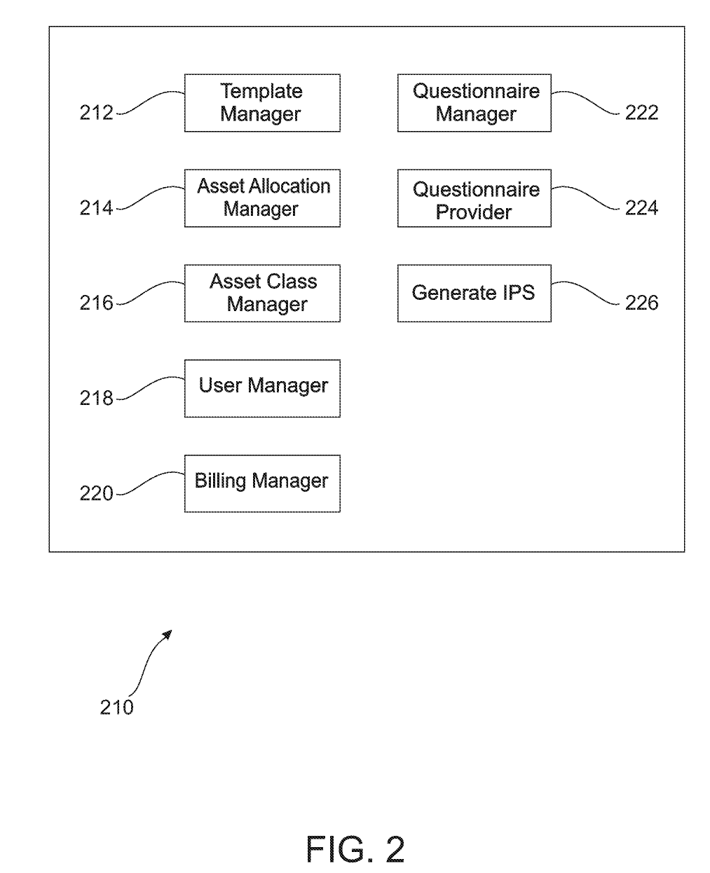

A block diagram of an Investment Policy Statement (“IPS”) system in accordance with one embodiment of the present invention is shown in FIG. 2. IPS system 210 includes a template manager 212, an asset allocation manager 214, an asset class manager 216, a user manager 218, a billing manager 220, a questionnaire manager 222, a questionnaire provider 224 and an IPS generator 226. Each of these software managers may be implemented as code segments on physical computer readable memory and each will separately be discussed in detail below. Additional, fewer, or different software managers may be incorporated into the system.

A user of the system is defined as a person who is creating or maintaining an IPS for a client. Generally, but not in all embodiments, the user will be an investment advisor. A client of the system is defined as a person or entity for whom the IPS is being generated. Generally, but not in all embodiments, the client is an investor.

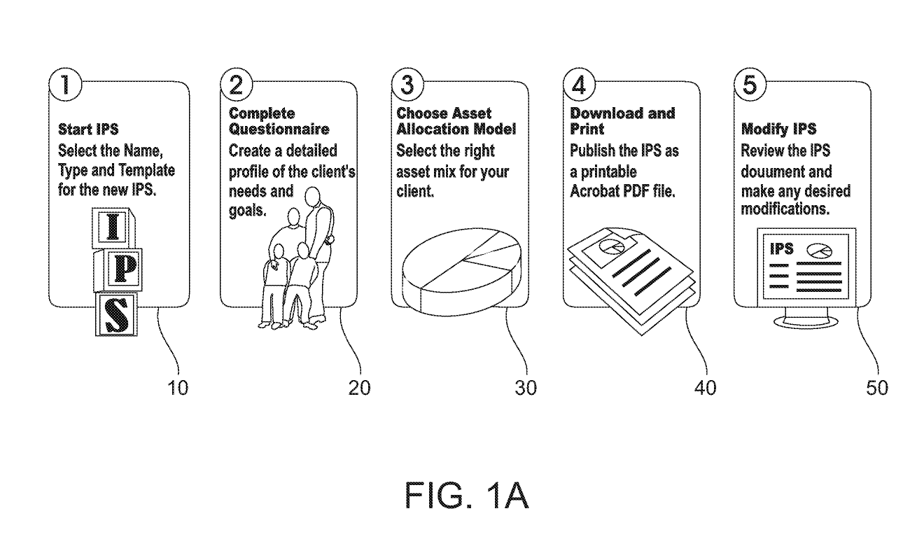

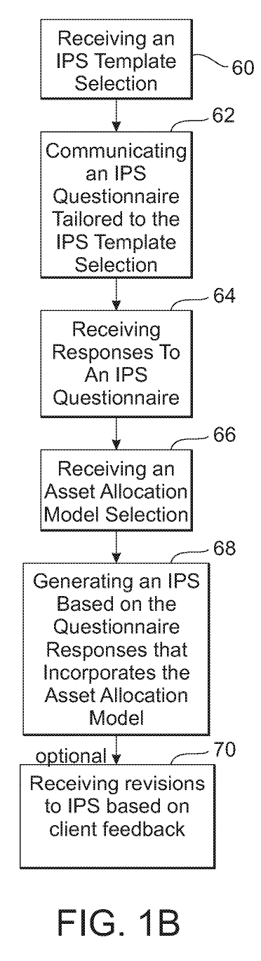

A flow chart illustrating the general method for creating an IPS from a user's perspective is shown in FIG. 1A. The method generally includes: 1) starting the IPS, 2) completing the questionnaire, 3) choosing an asset allocation model, 4) downloading and printing the IPS, and 5) modifying the IPS if necessary. A flow chart illustrating the general method for creating an IPS from the system's perspective is shown in FIG. 1B. The method generally includes: 1) receiving an IPS template selection, 2) transmitting an IPS questionnaire tailored to the IPS template selection, 3) receiving responses to an IPS questionnaire, 4) receiving an asset allocation model selection, 5) generating an IPS based on the questionnaire responses that incorporates the asset allocation model selection; and 6) receiving revisions to the IPS based on client feedback, if necessary. For example, in the current embodiment, an investment advisor, sitting in front of a computer, could meet with an investor, answer a questionnaire based on the investor's responses, input the responses into the system in real time, and print an investment policy statement generated by the system for the investor before the investor leaves the office.

II. System

The IPS system may be implemented as a stand alone software package, as a software package distributed over a network of computers, or using essentially any other appropriate software implementation. In one embodiment a single server serves various web pages associated with the system, but in alternative embodiments the server could be distributed across several computers. Additionally, the server may include one or more databases which are in communication with the rest of the system. The server may be connected to additional remote computer systems to obtain data or other information. A person of ordinary skill in the art would understand how to implement this system over a network, such as the Internet.

A user may access the server remotely. In one embodiment, remote access to the server is restricted, requiring the user to provide a password or other identification before accessing the system. The system may be implemented with varying levels of access, allowing IPS templates to be maintained at those levels. For example, there may be groups of investors who maintain IPS template paragraphs that individual investors in that group cannot modify or are forced to use. This essentially allows an efficient way to enforce compliance control. In addition to this compliance control, the administrators of a level have broadcast control. That is, the ability to update a single paragraph and have the changes broadcast to all investment advisors using those paragraphs.

As noted above, the IPS system 210 includes a template manager 212, an asset allocation manager 214, an asset class manager 216, a user manager 218, a billing manager 220, a questionnaire manager 222, a questionnaire provider 224 and an IPS generator 226. Various screen shots of the system interfaces are shown in the FIGs. A person of ordinary skill in the art would understand how to implement these interfaces in software as well as the database that they interact with. The depicted interfaces are web interfaces, but essentially any suitable interface implementation is possible. For example, in the depicted embodiment, the screenshots are of web interfaces that are capable of being displayed on a variety of web browsers, such as Internet Explorer 6.0 by Microsoft Corporation.

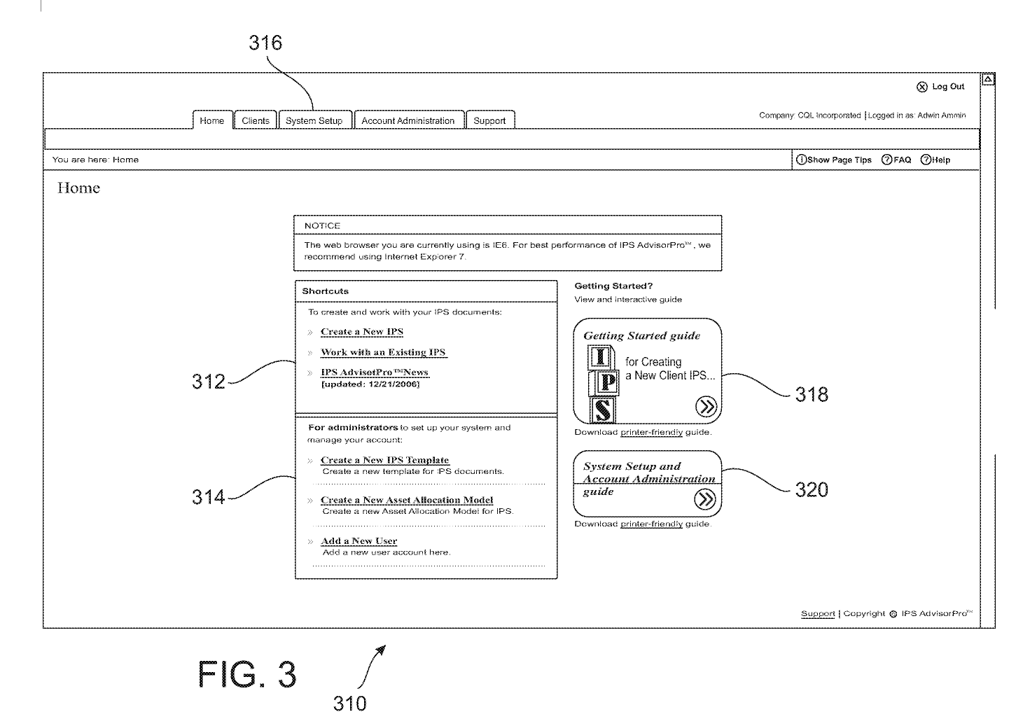

FIG. 3 shows an optional menu or home interface 310 that may be presented to a user upon entering the system to allow navigation within the system. Other layouts that include less, additional, or different information and links may be implemented. In the current embodiment, navigation box 312 provides shortcut links to create a new IPS, work with an existing IPS or to access news related to the IPS software. Administrator navigation box 314 is provided to those users who are also administrators. In one embodiment, administrators are allowed to create a new IPS template, create a new asset allocation model, or to add a new user. Additional, different or fewer administrator features may be provided in alternative embodiments. Navigation tabs 316 provides a user with an easy method to move between portions of the system. Navigation tabs 316 may be implemented differently or removed altogether from the home interface 310. Home interface 310 may also include links to a user guide 318 as well as an administrator guide 320. These guides may provide support documentation tailored to the user or administrator.

A. Investment Policy Statement System Setup

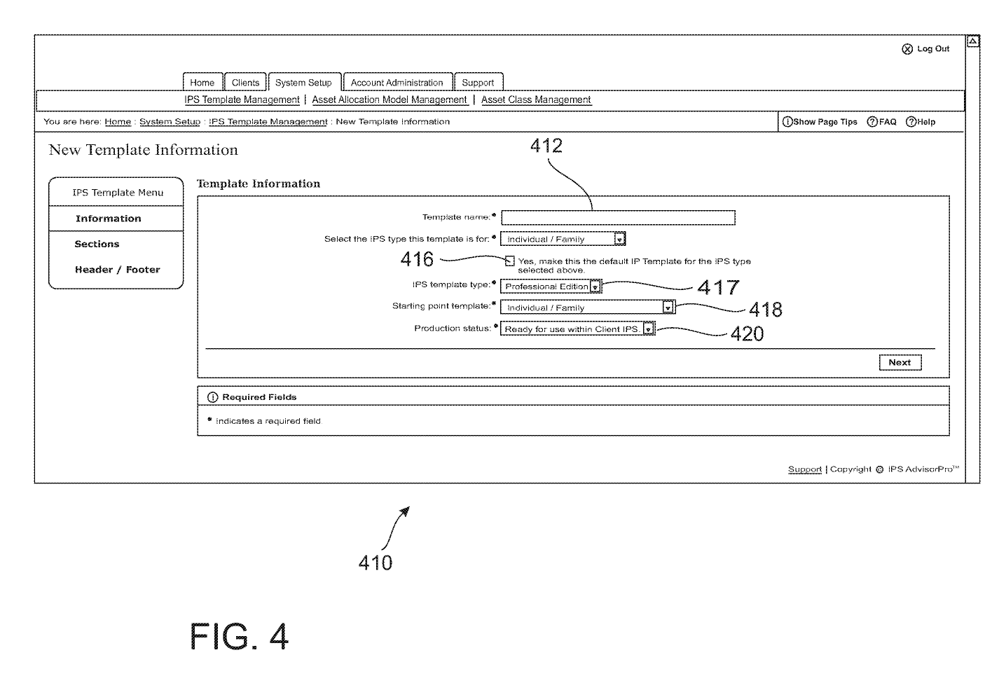

FIGS. 4 through 21 show the setup of the IPS system that the user typically goes through before preparing an IPS for a client. In the current embodiment, this setup is handled by a template manager and asset allocation manager. This setup typically need only be done once to configure the system for a particular investment advisor.

An IPS Template is the starting point for building an IPS. Some preconfigured templates may be provided by the system. Some users may want to edit the provided text, insert or delete sections, re-order the sections, or make other changes. Setting up the IPS system allows a user to make changes to the IPS templates. Eventually, for each type of client, there may be a separate template, so that all the user has to do is enter the unique data for that client, choose the appropriate investment model and print.

1. Template Manager

FIG. 4 shows one embodiment of a template creation interface. The template creation interface of the current embodiment is merely exemplary. A person of ordinary skill in the art would understand how to implement a different template creation interface with fewer or additional features. The template creation interface of the current embodiment includes a template name field 412, an IPS type field 414, a default indicator 416, an IPS template type field 417, an initial template field 418 and a production status field 420. IPS templates that are created with the interface may be stored in a database. Additional information, such as creation date and author, may be associated with the IPS in the database. In one embodiment, the creation date of the IPS is automatically associated with the IPS template in the database. In another embodiment, the creation date of the IPS may be manually entered as a field on the IPS template creation interface.

The template name field 412 identifies the template. The IPS type 414 indicates whether the template is for an individual/family, a trust, a charitable trust, an endowment/foundation, a pension plan, a self-directed 401(k) plan, a profit sharing plan, a life insurance policy, or other type of IPS. The default indicator 416 select whether or not the template is the default template for the selected IPS type. The IPS template type field 417 selects whether the template is a professional edition or standard edition template. Different template types may have varying degrees of complexity. Optional initial or starting point template field 418 selects which basic template is used as the basic building block for a production template. Production status field 420 indicates whether the template is ready for use with a client or if the template is no longer in use.

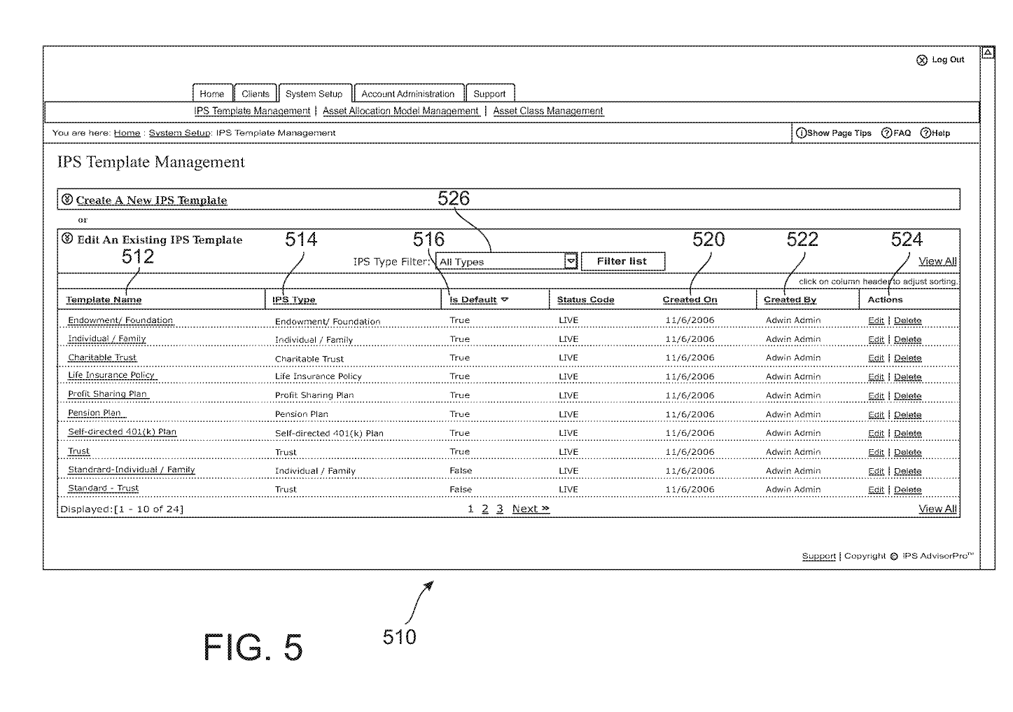

FIG. 5 shows one embodiment of an IPS template management interface 510. A person of ordinary skill in the art would understand how to implement a different IPS template management interface with fewer, different, or additional features. The current embodiment of the IPS template management interface 510 includes a table listing the available templates stored in the database with the following columns: the template name 512, the IPS type 514, whether the template is a default template 516, status code for the template 518, the date the template was created 520, the creator of the template 522, and the actions that can be taken 524 on the template. The actions column 524 allows a user to delete an IPS template from the database or to edit the IPS templates. Filter 526 allows a user to apply a variety of filters to sort or otherwise organize the templates.

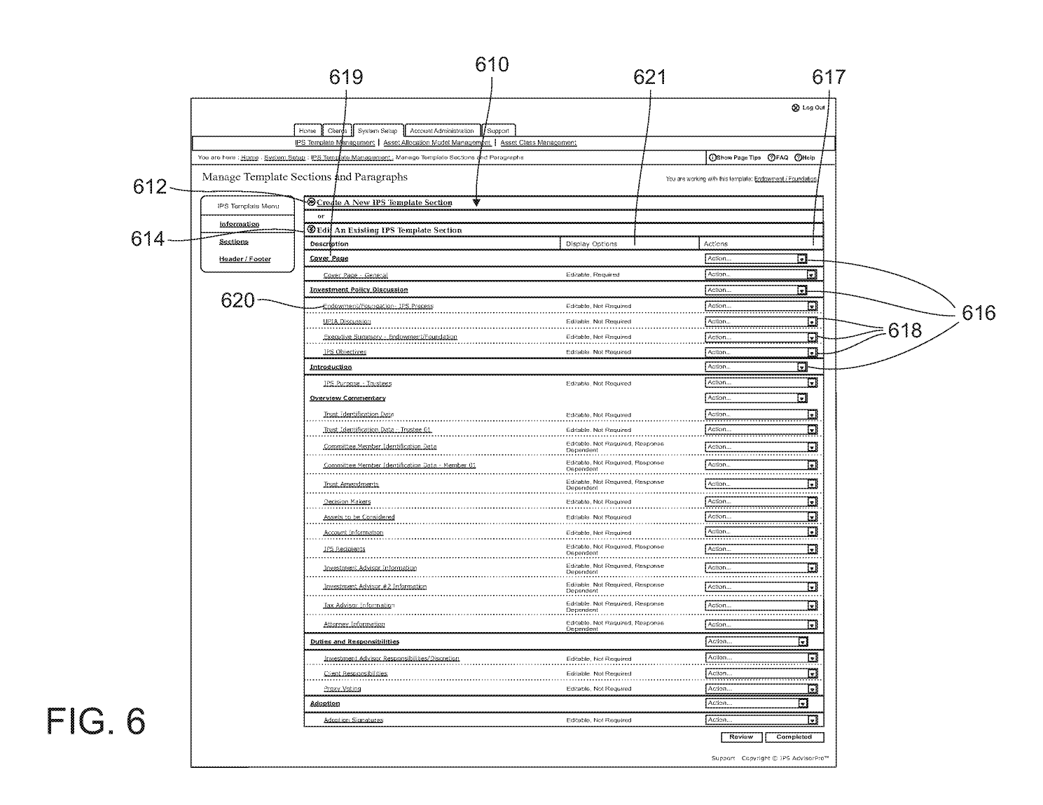

FIG. 6 shows one embodiment of a manage template sections and paragraphs interface 610. The template section-paragraph management interface may be implemented with less, different, or additional features. In the current embodiment, the template section-paragraph management interface 610 includes a link that allows a user to create new sections and paragraphs 612 and links that allow a user to edit existing sections and paragraphs 614. Through this interface, a user can either create a new section in the template by selecting Create a New IPS Template Section 612 or in the Edit an Existing IPS Template Section a user can edit an existing section by selecting 1) the name of the particular paragraph or Section; or 2) one of the actions in the drop-down menu in the far right action 617 column. The description column 622 which identifies the section or paragraph name. The display option column 621 identifies whether the section or paragraph is required or editable by an investment advisor. It may be beneficial to have paragraphs which are required and not editable by all investment advisors working together. In the current embodiment, sections 619 are noted by bolded labels, starting at the left margin. Paragraphs 620 are the sub-parts of each section and are noted by non-bolded labels, indented from the left margin.

In the current embodiment, the action menu offers several options: Edit, Move, Remove, New Section/Paragraph Above/Below, Insert a pre-existing paragraph, New Paragraph. Edit allows a user to change the words or the format of the paragraph/section. Move allows a user to keep the existing wording or format, but change the location of the particular paragraph/section. Remove allows a user to delete the identified paragraph/section. A warning and confirmation may be implemented. New Section/Paragraph Above/Below permits a user to insert a new section or paragraph into an exact location. Insert a pre-existing paragraph allows the insertion of pre-made paragraph. New Paragraph allows the creation of a new paragraph from scratch. The Make/Adjust response dependent option allows a user to set response dependency of a particular section or paragraph.

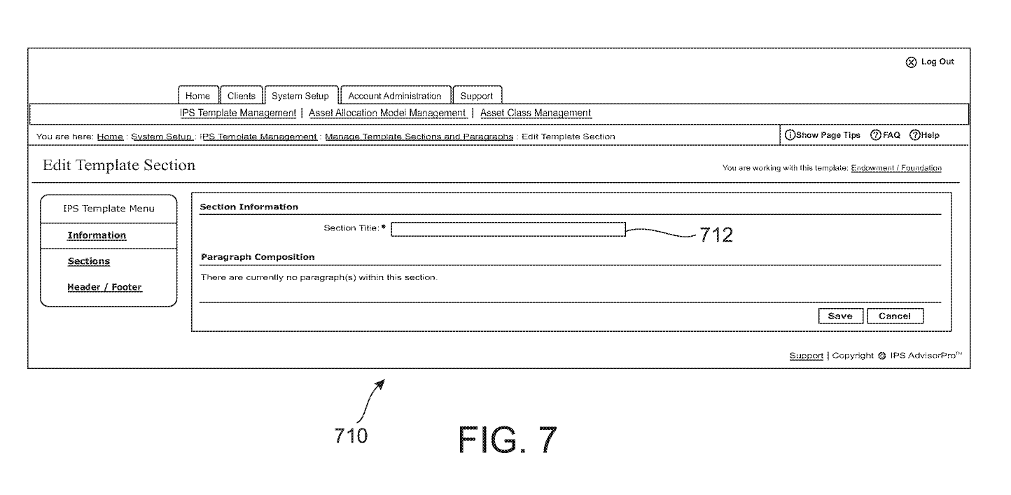

FIG. 7 shows one embodiment of an edit template section interface 710 for creating a new template section. A user may enter a title for the section in the title field 712. Once the section is created, paragraphs may be associated with it. In the current embodiment, after creation of the section, the user is automatically returned to the template section-paragraph management interface 610.

Returning to the manage template sections and paragraphs interface of FIG. 6, as noted above, a user can edit an existing IPS template section. A user can either edit a section by way of one of the selection menus 616. A user can also edit a paragraph of the IPS template by way of one of the menus 618.

In the current embodiment, the IPS generally includes an investment objectives section, a time horizon section, a tax policy section, a risk tolerance section, an asset allocation section, an advisor philosophy section, and a diversification and investment constraints section. These sections are merely exemplary; additional, different, or fewer sections may be included. Each of these sections generally includes related paragraphs of investment policy language. As will be discussed in more detail below, questions on the investment policy questionnaire may be related to these or other sections and the paragraphs associated with them.

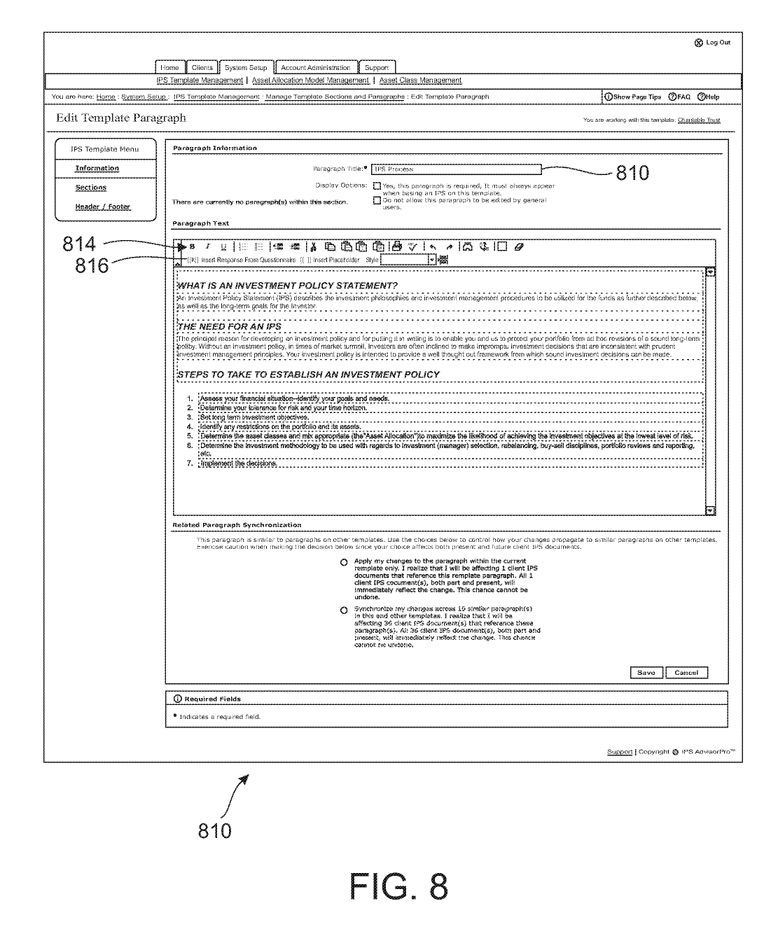

If a user selects Edit or New Paragraph from menus 616, 618, the edit template paragraph interface 810 is displayed, as shown in FIG. 8. In the current embodiment, a text editor allows the user to create or modify the text of an IPS paragraph. This allows a user to make edits to a single template paragraph instead of having to edit each individual IPS paragraph. A title may be entered for the paragraph in the paragraph title field 812. In the current embodiment, the edit template paragraph interface 810 includes two additional features, a required indicator 814 and a lock indicator 816. The required indicator 814, when selected, specifies that the paragraph be present in an IPS using the template. The lock indicator 816, when selected, prevents any other user from editing the wording or formatting of the paragraph. This is especially useful if the system is used by an organization with many different users. Certain paragraphs could thus be maintained consistently across an organization using the system.

To enter the words, the paragraph editor works similarly to any generic text editing software that offers the ability to add, change or delete words or paragraphs. The various icons 814 may be used to modify the formatting.

Paragraphs may include response dependent fields which are fillable depending on one or more responses from the client questionnaire. Response dependent fields may be inserted into the paragraph using a placeholder word, for example, a firm's name (“AdvisorFirmName”). This feature is offered by the “[[R]] Response from Questionnaire]” link 816. Selecting this link will bring up a list of placeholder words. For example, in the current embodiment, “AdvisorFirmName” is one such placeholder word. Selecting the placeholder word will insert it in the paragraph. There need not be a one-to-one mapping of questionnaire answers to response dependent fields. For example, a set of responses could provide a score which indicates the appropriate language to include in the response dependent field or a single response could indicate the appropriate language to include in multiple response dependent fields. In one embodiment, the placeholder is collapsible if the responses dependent field it maps to is blank.

In addition, in the current embodiment, paragraphs may be synchronized across multiple templates. For example, an ERISA discussion paragraph may be standard and appear in multiple templates. A user may make a change to the ERISA paragraph and choose to synchronize or cascade that paragraph language to other similar paragraphs in other templates.

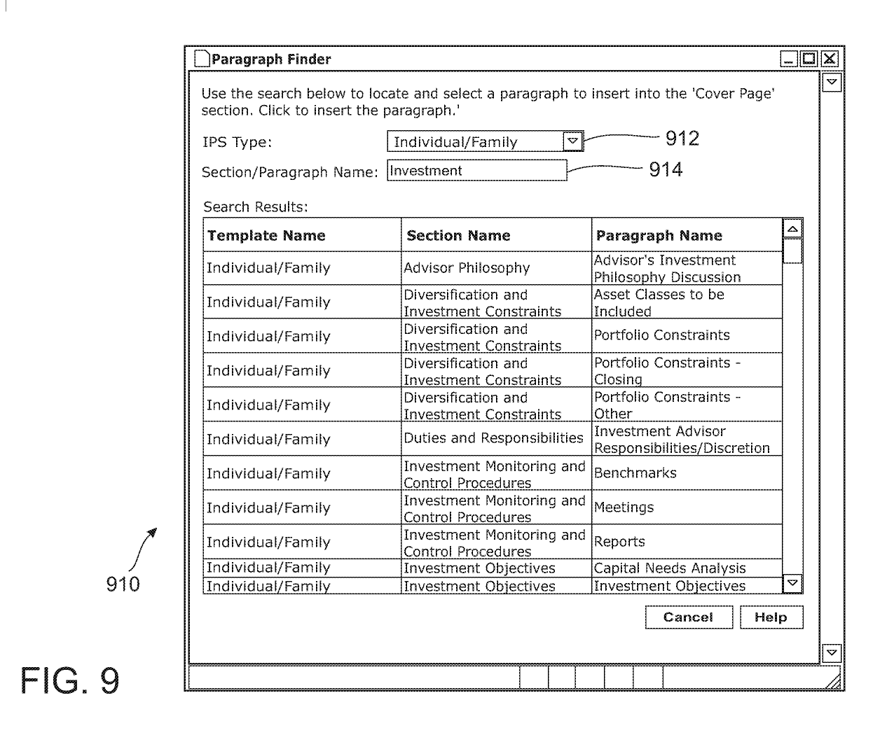

A user may also insert preexisting paragraphs into the IPS. A paragraph finder allows a particular preexisting paragraph to be located and one embodiment of an exemplary paragraph finder is depicted in FIG. 9. In the depicted embodiment, the IPS type 912 and a portion of the paragraph or section name 914 are entered and the search results are displayed in a separate area. In one embodiment, the search results may be filtered by various criteria. A person of ordinary skill in the art would understand how to implement a paragraph finder with additional, different, or fewer features.

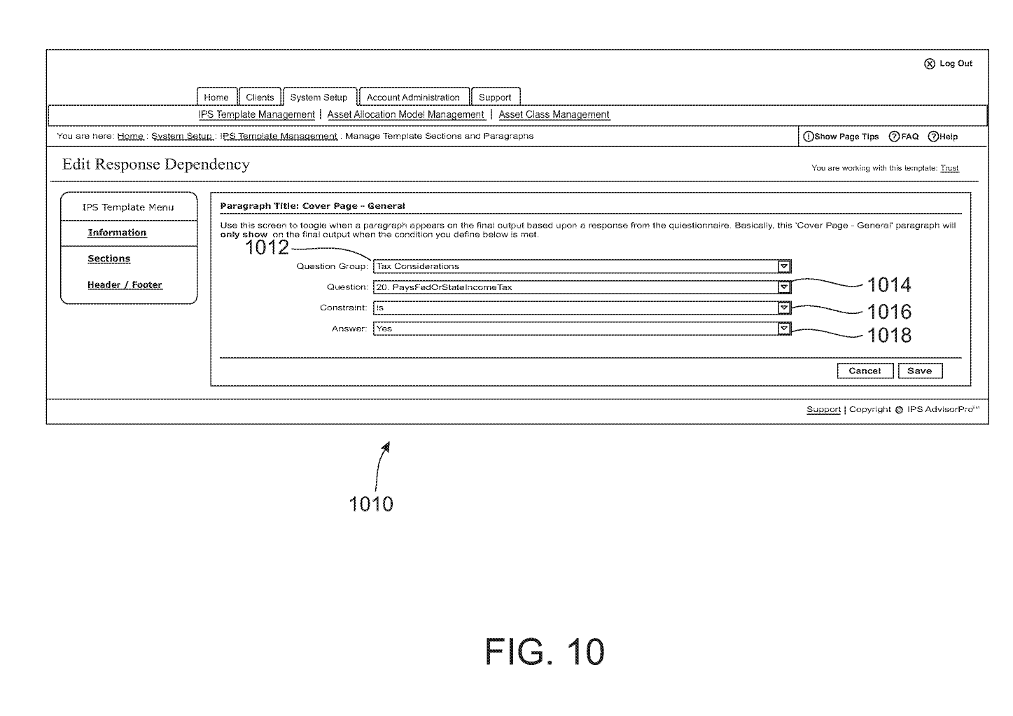

If a user wishes to change the response dependency, a response-dependency interface may be used. An exemplary response-dependency interface 1010 is shown in FIG. 10. As previously noted, response dependency refers to completing a paragraph or section either by filling in a field or by deciding whether a paragraph or section should be shown or hidden within the IPS based upon a response to a pre-defined question. In the current embodiment of the response-dependency interface, a user selects a question group in menu 1012. A pertinent question is selected in menu 1014. Menu 1016 allows a constraint to be selected. A constraint could be “is”, “is not”, “is blank” or “is not blank” among other things. Text entry field 1018 allows the user to indicate an answer for the question. A person of ordinary skill in the art would understand the response-dependency interface could be implemented with less, different, or additional features.

A “Response Dependent Paragraph” is one that may change depending on how a user answers a question in the questionnaire. As an example, in the questionnaire, a client may be asked if the investor is taxable or not. If the answer is “yes” then one paragraph will be printed in the IPS. If the answer is “no” then it might be that either no paragraph is printed or that a paragraph with different wording is printed. Which paragraph shows up, or whether one shows up all, would be “response dependent”—in other words, relying on a user's response to determine what should be done. Each paragraph in each of the templates could potentially be response dependent. In one embodiment, the system includes the ability to handle complicated Boolean logic to toggle response dependency.

The question group menu 1012 defines where in the questionnaire the question and the answer can be found. For example, the relevant question may be in the “Client Information” section or in “Economic Assumptions.” The Question menu 1014 defines a specific question in the Question Group. In the current embodiment, the available questions are numbered to identify the specific question within the questionnaire and only those questions in the identified question group are available. The Constraint menu 1016 defines the finite number of answers for each question. Based on the question identified the menu allows a user to select from the available possible answers for that question. The Answer field 1018 allows the IPS to act in a unique way depending on which constraint is chosen. Whenever a client answers the selected question in the selected way, their IPS will have the wording provided in this field in that place in the IPS.

For example, in a question about benchmarking, in the asset allocation section of the questionnaire. The question may ask “Do you provide benchmarks for portfolio evaluation?” and the choices are yes or no. If “yes,” the user will be able to select the favored benchmarks. If the answer is “no” then nothing about benchmarks will be printed in the IPS. In the current embodiment, if there is no response at all, nothing is printed.

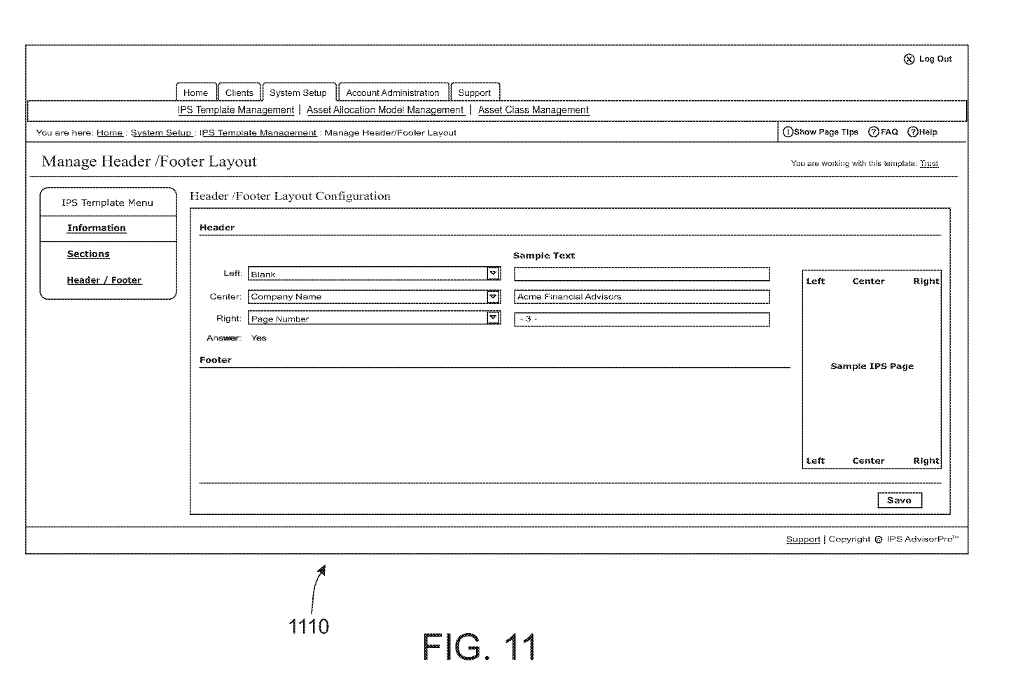

FIG. 11 shows a manage header/footer editing interface 1110 for adding header or footer information to the IPS. Header and footer information is optional in an IPS.

2. Asset Allocation Manager

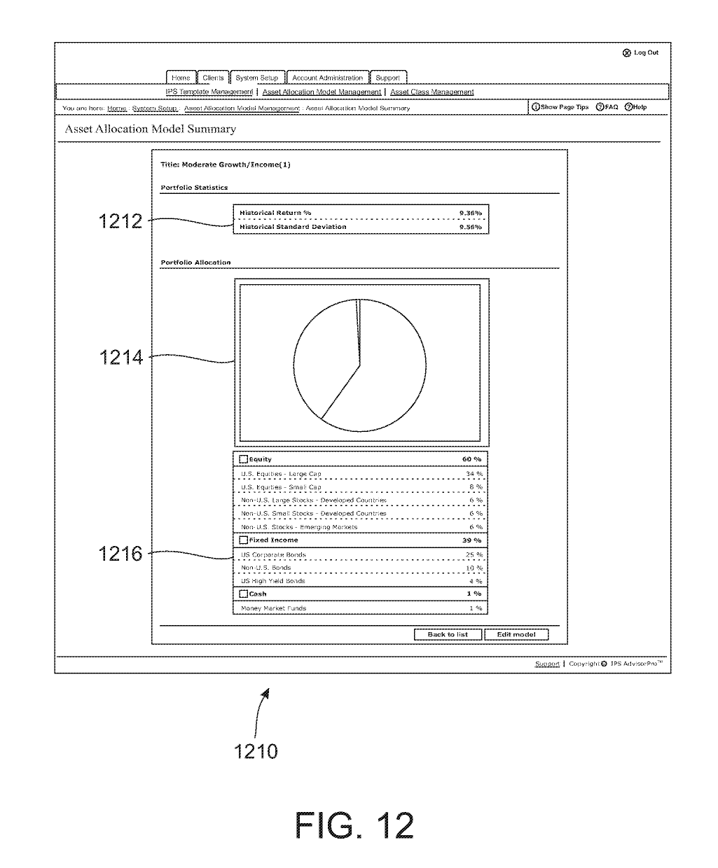

Returning to FIG. 3, a link is provided in navigation box 314 that allows a user to configure the system to create, manage, and ultimately incorporate asset allocation models into an IPS. An asset allocation model is one tool to select investments, and while not mandatory, it may enhance an IPS. Asset allocation models assist in determining how an investment portfolio is structured. Asset classes are the building blocks used to construct an asset allocation model. FIG. 12 shows an asset allocation model 1210. The asset allocation model provides historical return information 1212 indicating the historical rate of return and the historical standard deviation of the rate of return. The historical standard deviation is one aspect of the risk of an investment. Pie chart 1214 provides a graphical representation of the allocation of the investments for this model. Investment information 1216 shows a further breakdown of the asset allocation model. In some embodiments, the data may not always be historical. For example, in one embodiment, users may modify the data to their own taste.

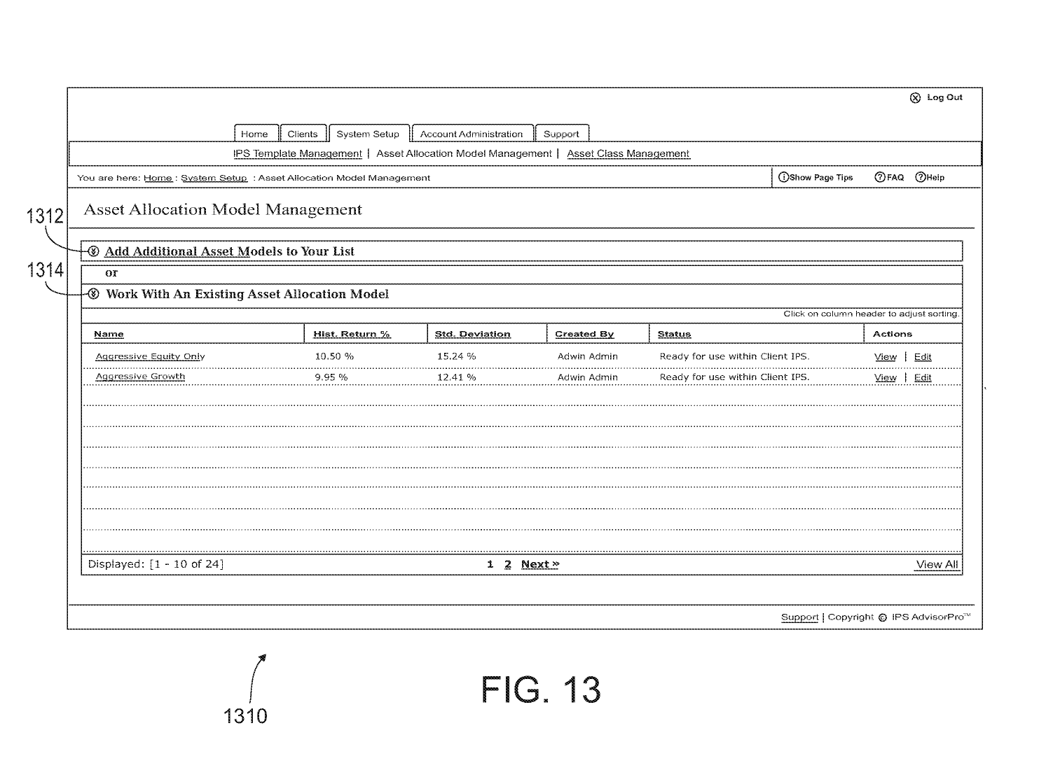

FIG. 13 shows an asset allocation model management interface 1310. A user can activate the “Add an Additional Asset Model to Your List” link 1312 to add one or more of the provided Asset Allocation Models to a menu of choices or activate the “Work with an Existing Asset Allocation Model” link 1314 to view or edit one of the pre-existing models. The “Add an Additional Asset Model to Your List” link 1312 will also allow a user to access a “Create a New Asset Allocation Model” link to create a new Asset Allocation Model which links to an interface with a list of asset classes to build a new model. This is merely an exemplary embodiment of an asset allocation model management interface 1310. A person of ordinary skill in the art would understand how to implement an interface with additional, different, or fewer features.

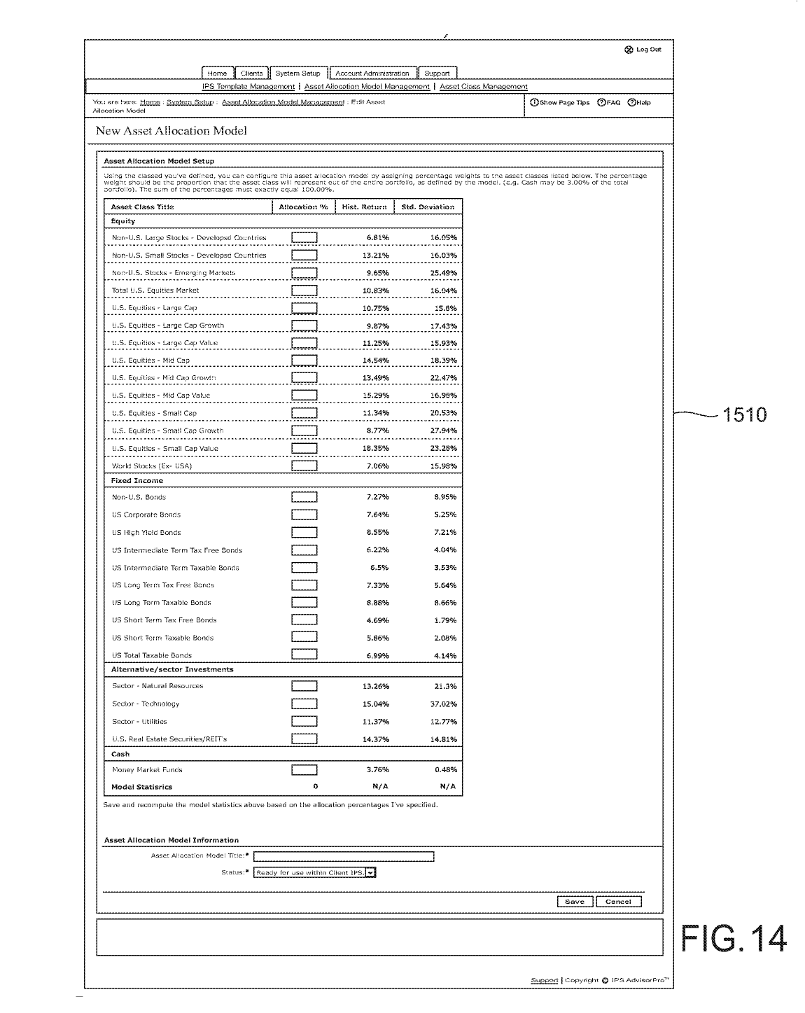

FIG. 14 shows the current embodiment of the asset allocation model creation interface 1510. Asset allocation model setup 1512 allows a user to enter allocation percentages for each type of asset class available in the user's system. In one embodiment, each user has access to a specific list of asset classes, which may include pre-set asset classes and any of the user's own custom asset classes. Thus, a user can create a specific asset allocation model tailored to the client's needs and then have that model available for use with future clients. Users may choose to use a pre-set asset allocation model or may create their own asset allocation models. In the current embodiment, there are six pre-set asset allocation models. A person of ordinary skill in the art would understand how to both create an asset allocation model and how to implement an asset allocation model creation interface.

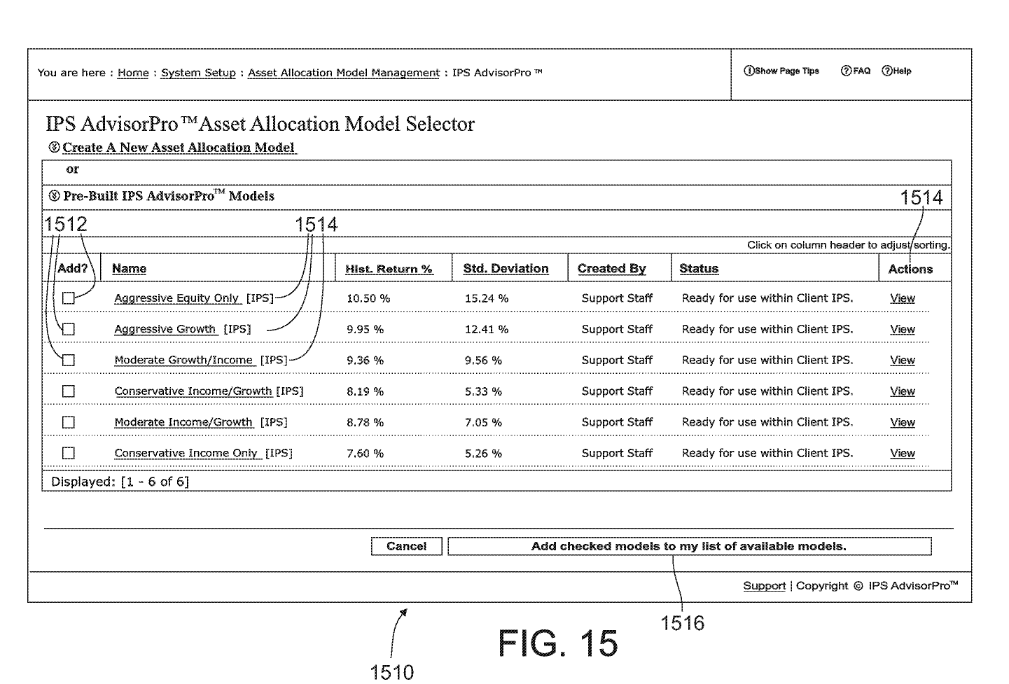

FIG. 15 shows one embodiment of an asset allocation model selector 1510. Various information about available asset allocation models is shown. The name and historical return for each model is shown, along with the standard deviation of the historical return, the creator of the model, and the status of the model. It is also possible to view each model using the name or view link 1514. If selected, information concerning the asset allocation model is displayed, similar to that shown in FIG. 12. A column of check boxes 1512 allows a user to select which asset allocation models should be added to the list of available models including user-created models. After selecting the desired models, a user may select the “Add Checked Models” link 1516, which makes the models available for selection on the interface shown in FIG. 13.

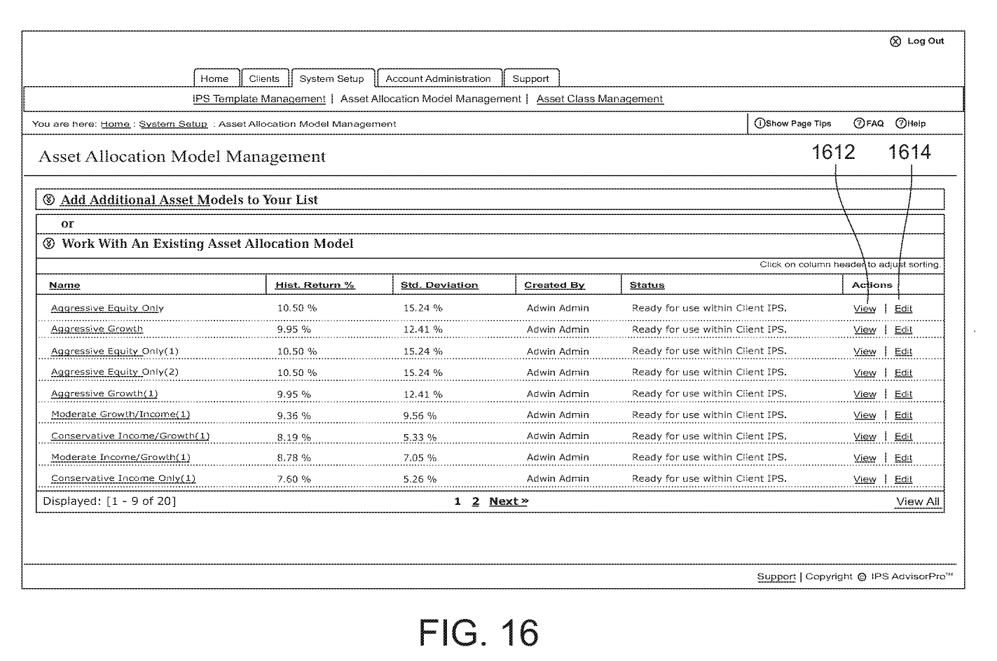

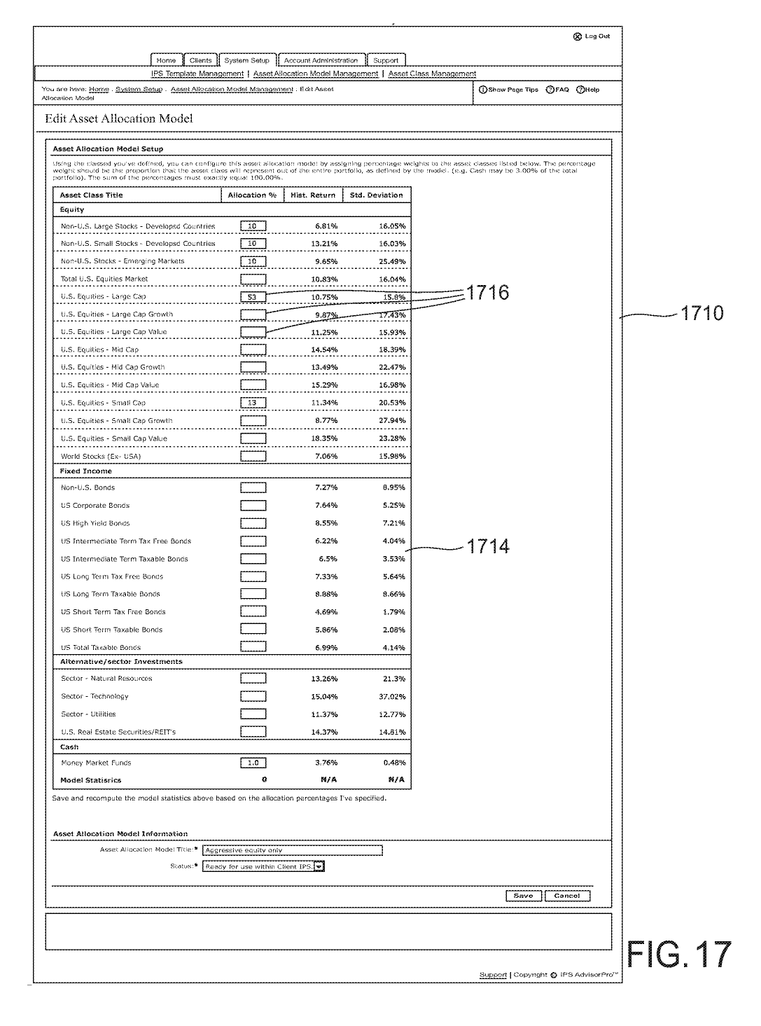

FIG. 16 shows the same interface that was shown in FIG. 13 after some additional asset allocation models have been added by way of asset allocation model selection interface 1510. A user may view or edit each asset allocation model. If a user selects the “View” link 1612, then the asset allocation model is displayed, similar to that shown in FIG. 12. If a user selects the “Edit” link 1614, then the user is directed to an edit asset allocation model interface 1710, shown in FIG. 17.

FIG. 17 shows an edit asset allocation model interface 1710. In the current embodiment the edit asset allocation model interface 1710 is nearly identical to the new asset allocation model interface 1510 shown in FIG. 15. The main difference between them is that the edit asset allocation model interface 1710 has values for an asset allocation model already filled in that can be changed. In the current embodiment, the edit asset allocation model interface 1710 allows the allocation percentages of each asset class to be altered as long as the sum equals 100%.

Asset class title 1714 shows the names of various investments such as U.S. Equities—Large Cap and Non-U.S. Bonds. Allocation percentages 1716 are user editable fields where a user can adjust the allocation for each type of investment. For example, a user, if desired, could increase the investment for U.S. Equities Large Cap to any percentage up to 100%. The historical return and the standard deviation for each investment are also displayed. The title of the asset allocation model can be entered, as well as whether the model is ready for use. A [D] may appear next to an asset allocation model to indicate that the particular investment is deactivated. If a [D] does not appear, then the investment can be used. In some embodiments it is also possible to manage the asset classes that appear in the asset class title 1714.

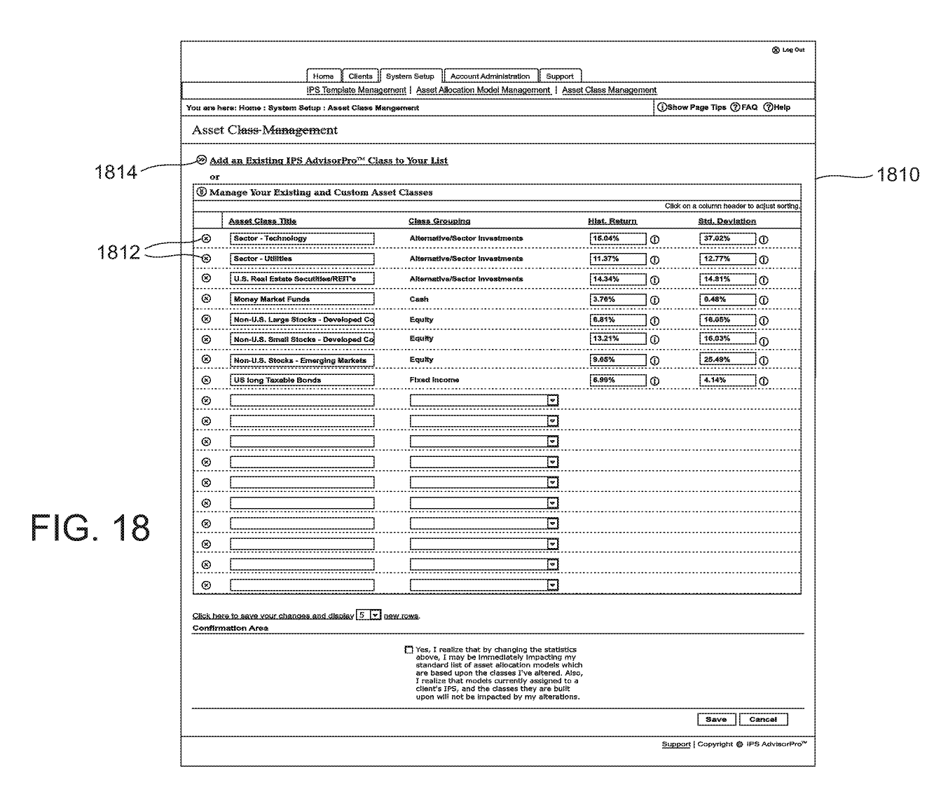

FIG. 18 show an asset class management interface 1810. Asset classes are the building blocks to construct an asset allocation model. As part of the setup of the asset allocation models, the various asset classes that will make up the models should be defined. The system provides a list of asset classes that may be used or deactivated. Custom asset classes may also be implemented.

A list of some of the asset classes provided by the system are shown in FIG. 18. The “X” link 1812 on the left of each asset class in the list can be used to activate or deactivate each asset class. Permission to activate or deactivate may be restricted based on a user's access level to the system. Deactivated asset classes will not appear on this list. Deactivated asset class may be added back later using the “Add an Existing IPS AdvisorPro™ Class to Your List” link 1814.

A user may review and revise the volatility statistics of each asset class. In the current embodiment, the system provides historical annual return numbers back to 1991 (or shorter, if the data was not available) from publicly available sources. Past returns may not reflect the client's or the user's view of the long-term projected returns for a particular asset class. The system therefore allows the user to revise the return and volatility data to reflect the user's unique insights about expected risk and return.

As for standard deviation returns, in the current embodiment, the standard deviation for each asset class is based on available historical data, back as far as 1991. Similar to historical return, a user may review and revise the standard deviation for each asset class.

The return and standard deviation asset class statistics are used by the system to calculate portfolio statistics, for example, return and standard deviation. If a user substitutes their own numbers for the provided ones, or if an Asset Allocation Model utilizes an asset class a user created, the system may not calculate portfolio statistics automatically, and instead may ask the user to provide them.

To create a custom asset class, a user types a name in the first column, and selects a general type of asset classes from a drop down list.

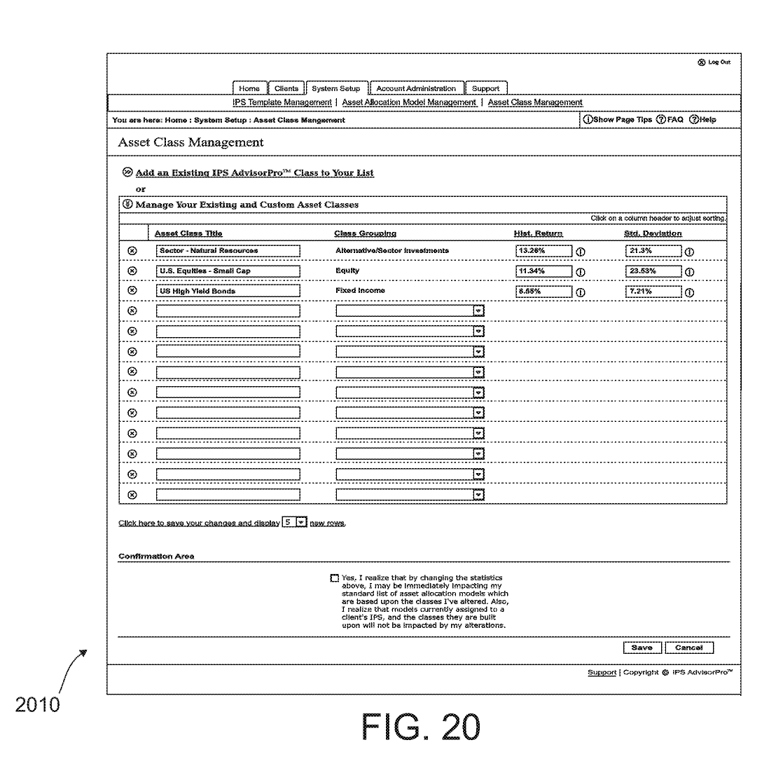

As perhaps best shown in FIG. 18, an existing asset class may be added and the entire list of asset classes can be managed by way of interface 1810. FIG. 20 shows another portion of the asset class management interface shown in FIG. 18 after the addition of three new asset classes and deletion of the old ones. From this interface, it is possible to change the asset class title, the historical return and the standard deviation for each asset class provided by the system.

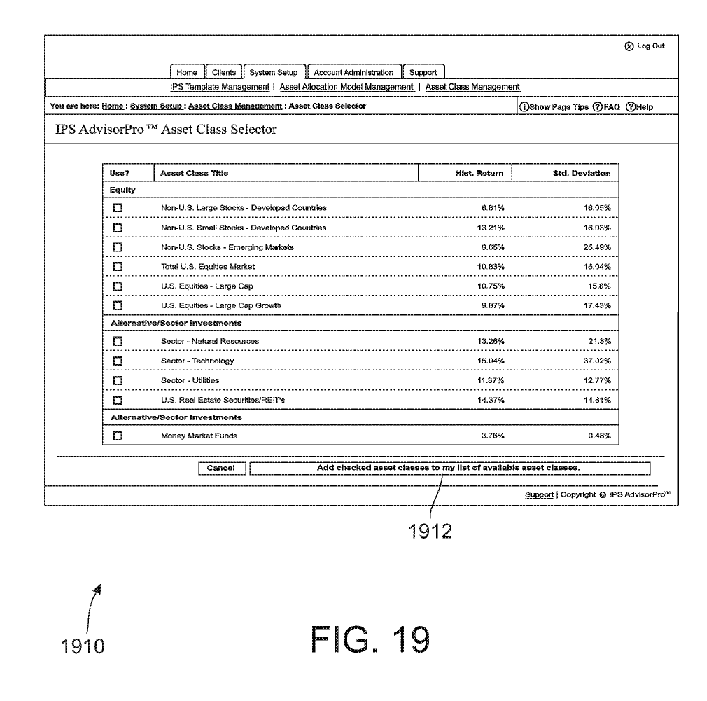

FIG. 19 shows an asset class selector interface 1910. A user selects the asset classes desired. Again, the historical return information as well as the standard deviation is shown. When the desired asset classes are selected, the user may add the selected asset classes to the list of available asset classes by selecting the “Add checked asset classes” link 1912.

3. User Manager

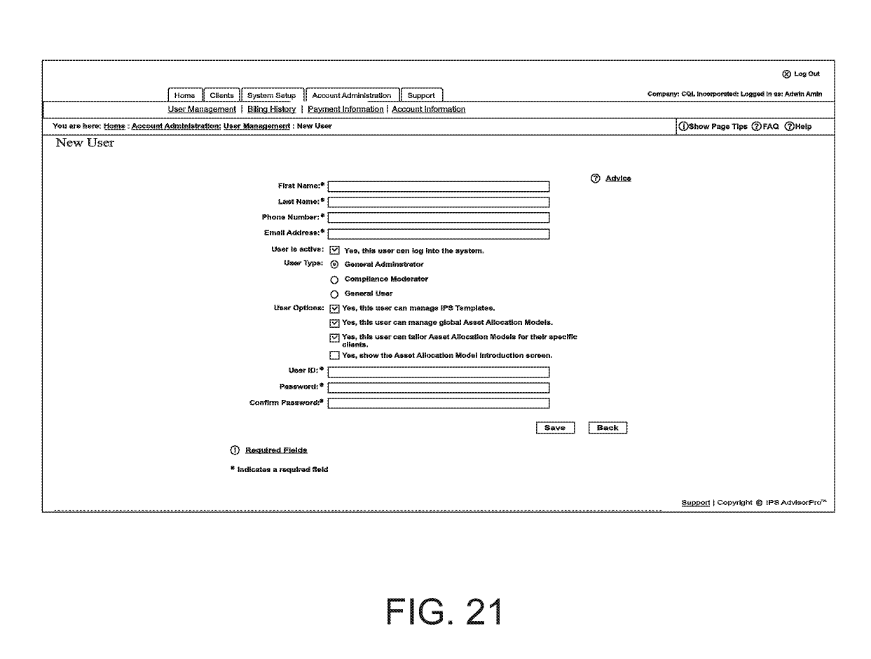

A user manger may be implemented in the IPS system. In one embodiment, the user manager allows management of one or more users accessing the IPS system. FIG. 21 shows an exemplary interface for adding a new user. In the current embodiment, there are three levels of users: general administrators; compliance moderators; and general users. The user's name, phone, email, usage rights, password and User IDs may be entered into the system using this interface. A user manager with additional, fewer, or different features may be implemented. A person of ordinary skill in the art would understand how to implement such a user manager. In addition, each user may have different rights depending on the administrator. Administrators provide the system with compliance control. For example, the restriction or presence and editability of words in paragraphs is one control mechanism that may be used for compliance control.

4. Billing Manager

A billing manager may be implemented in the IPS system that informs the user about when and how much they were billed to use the system. A person of ordinary skill in the art would understand how to implement such a billing manager.

B. Investment Policy Statement System Use

In the current embodiment, a user may begin creation of an IPS with or without customizing the system. For example, the user may or may not alter or make additions to the premade asset allocation models and paragraph verbiage. In the current embodiment, users tailor existing or create new IPS templates to fit their specific needs.

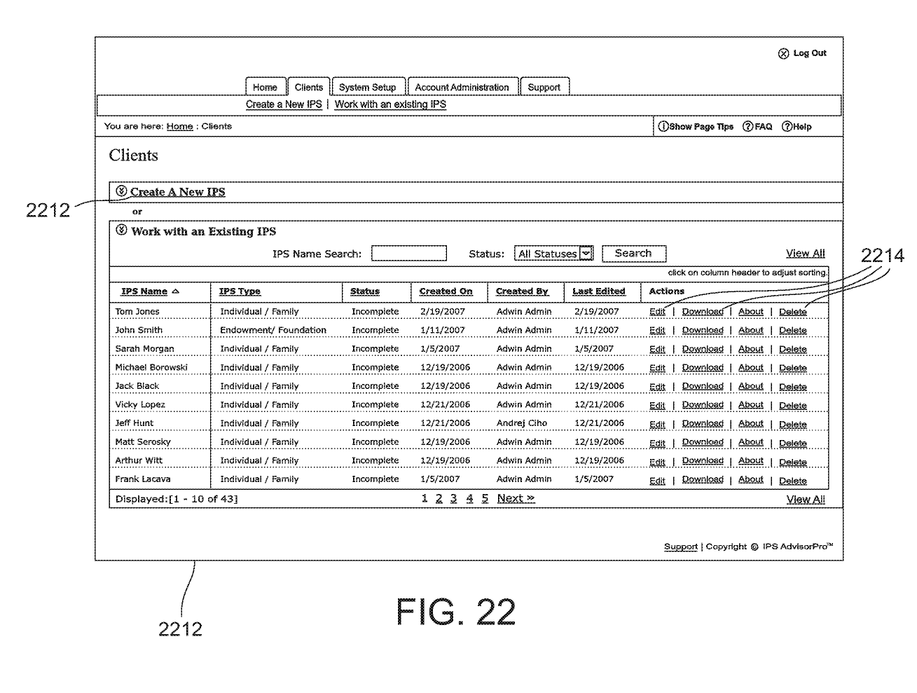

FIG. 22 shows one embodiment of a client interface 2210 where new IPSs may be created or existing IPSs may be maintained. Selecting the “Create a New IPS” link 2212 leads through a several step process to build a new IPS. Selecting one of the action links 2214 associated with an existing IPS allows a user to edit, download, learn about, or delete that IPS.

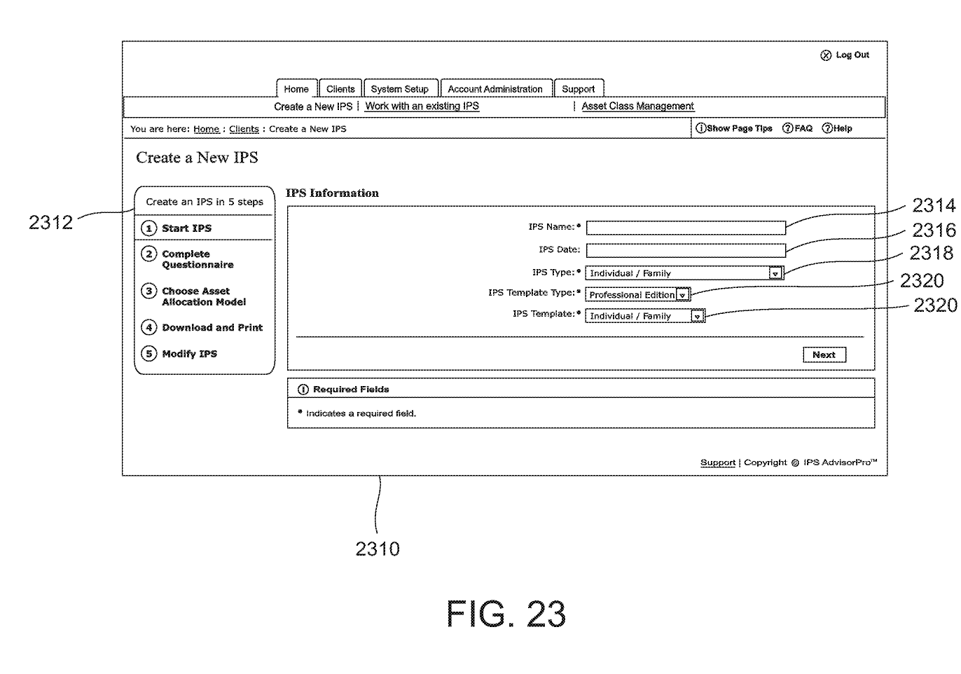

FIG. 23 shows an IPS creation interface 2310. In the current embodiment, interacting with this interface is the first of five steps in the system process from the user's perspective to create an IPS. In the current embodiment, a user uses this interface to enter preliminary information about the IPS to be created. All five steps are shown on the left navigation box 2312.

The IPS creation interface 2310 is used to identify an IPS name, IPS Date, IPS Type, IPS Template Type, and IPS Template. The IPS Name field 2314 identifies the name of the IPS. In the current embodiment it is usually the client's last name, then first name or the unique name of the trust or the institution. The IPS Date field 2316 identifies the date the IPS was created. In the current embodiment, the IPS Type menu 2318 is a drop-down menu that identifies the type of client. In the current embodiment the options available are individual/family, a trust, a charitable trust, an endowment/foundation, a pension plan, a self-directed 401(k) plan, a profit sharing plan, a life insurance policy. Other IPS Types may be available in alternative embodiments. In the current embodiment, the system includes templates for eight client types. Each client type may utilize the standard or professional version. In addition, the client type may have one or more than one template that reflects differences among those within that client type. The IPS Template menu 2312 allows a user to select a template for the basis of an IPS. In the current embodiment, the system includes eight templates, one for each client type. The system may also store templates that are built in the system, which allows users to reuse templates that are prepared for one client for another client.

Referring back to FIG. 2, generally, the questionnaire manager 222 selects questions to be answered, the questionnaire provider 224 provides questions selected by the questionnaire manager 222 to the user, and the IPS generator 226 creates the IPS for a client based on the responses to the questions. Generally, a questionnaire is a series of questions that may be used to build a comprehensive client profile.

1. Questionnaire Manager

The questionnaire manager is the software which manages which questions are associated with which questionnaires. Access to the questionnaire manager may be restricted to particular users. In the current embodiment, the questions and their relationship to questionnaires are only modifiable by administrators. It is worth noting that a single question may be associated with multiple IPS types.

2. Questionnaire Provider

The questionnaire provider provides the questionnaire to the user. In the current embodiment, the user will typically ask the questions on the questionnaire to the client who will provide answers in real time. In alternative embodiments, the client may be allowed time to complete the questionnaire on paper and then have the option of reviewing the questionnaire with the investment advisor before the advisor enters the data. In the current embodiment, the system automatically incorporates the questionnaire responses or profile data into the appropriate sections of the IPS as fully compliant statements. In the current embodiment there are many parts to each questionnaire, usually with several questions in each part.

In general, a questionnaire includes one or more questions and may include multiple questionnaires covering a number of different topics. For example, in the current embodiment, the questionnaire includes an economic assumption questionnaire, an investment objective questionnaire, a time horizon questionnaire, a tax consideration questionnaire, and a risk tolerance questionnaire.

A person of ordinary skill in the art would understand that additional, different, or fewer questions could be part of the questionnaires. A user may print out a questionnaire for a client to complete or a user may complete the questionnaire in real time. Eventually the responses to the questionnaire are entered into the system so that the information can be processed and inserted by the system in appropriate places in the IPS.

It is possible to skip some responses and come back later to fill in the missing questionnaire sections, or if they are not applicable to the client, it may be possible to delete and collapse portions of the IPS that are not applicable. In one embodiment, a navigation box with a link to each of the questionnaire sections is displayed on each interface. At the bottom of each interface there is a “Save and Continue” link, which saves the responses to the questions on that interface in a database and moves the user to the next interface.

The exemplary questionnaires discussed below are examples of printed questionnaires. A person of ordinary skill in the art would understand how to implement these questionnaires as interfaces which save responses to the database in the system.

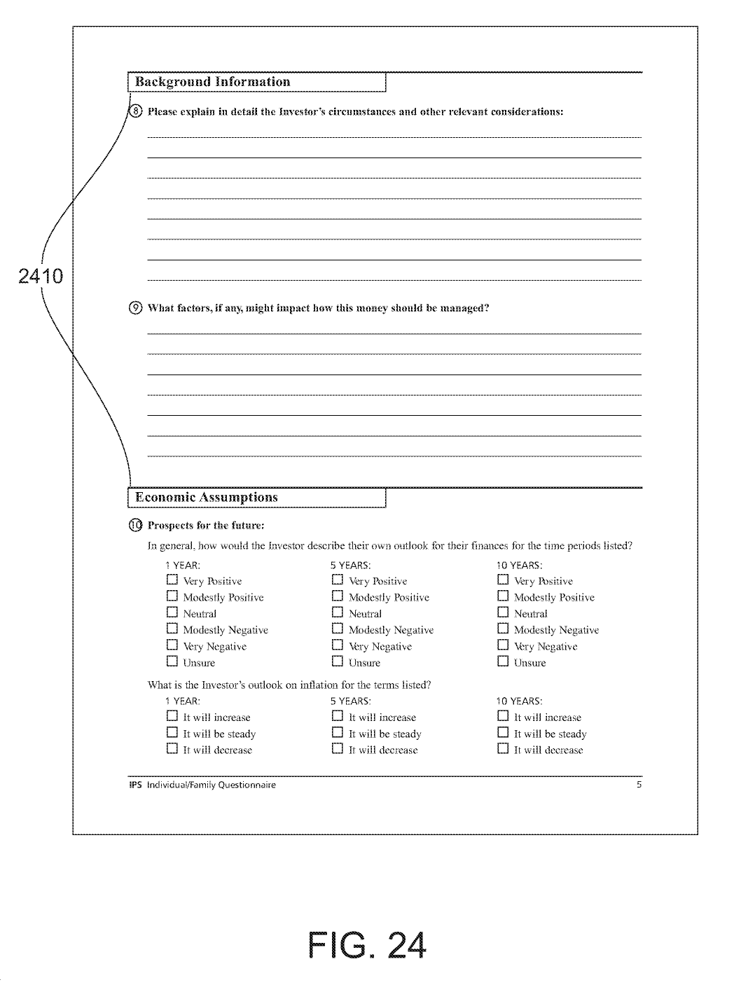

An exemplary background information and economic assumption questionnaire 2410 is shown in FIG. 24. In the current embodiment, this questionnaire allows a user to describe the key economic assumptions the adviser and client are making in order to structure the portfolio. It also poses questions about the client's perception of the current investment environment and the overall outlook for the broader economy. Additional questions may concern the economic outlook as identified by the client, in other words, whether money will be coming into the portfolio or going out. In one embodiment the questionnaire poses questions about whether the client is positive or negative about the short term, and the long term and about inflation.

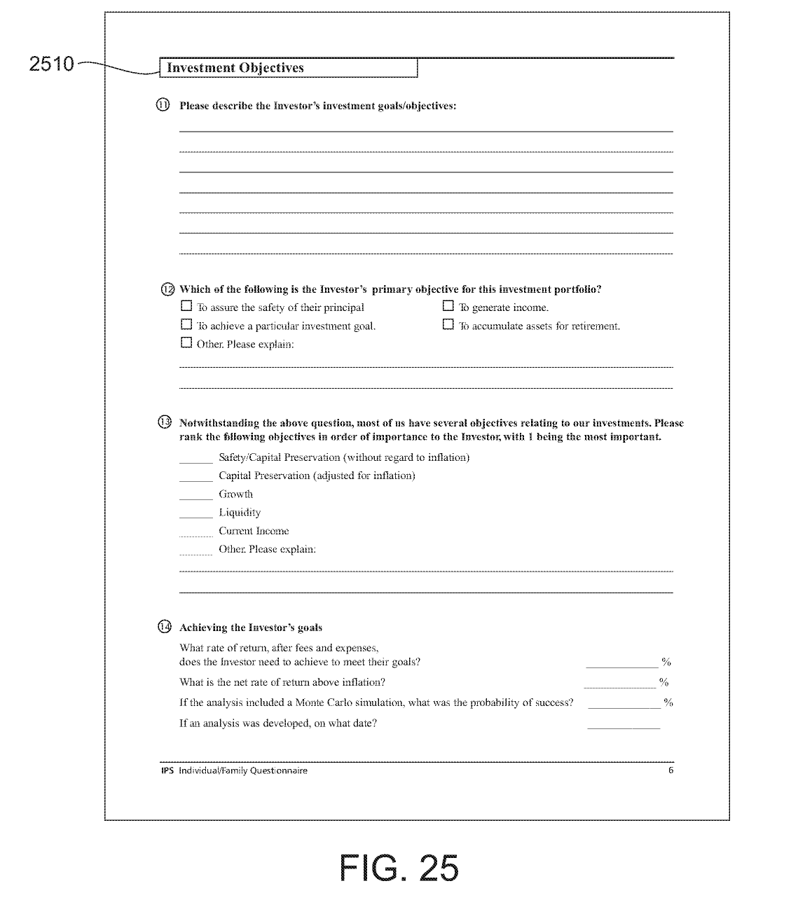

An exemplary investment objective questionnaire 2510 is shown in FIG. 25. In the current embodiment, this questionnaire merely calls for a simple statement of the client's investment objective. For example, one such statement is that “the insured wishes to have the cash value grow sufficiently to support the contract expenses until it matures or endows while at the same time taking as little risk as possible.” This verbiage should reflect the client's investment objective.

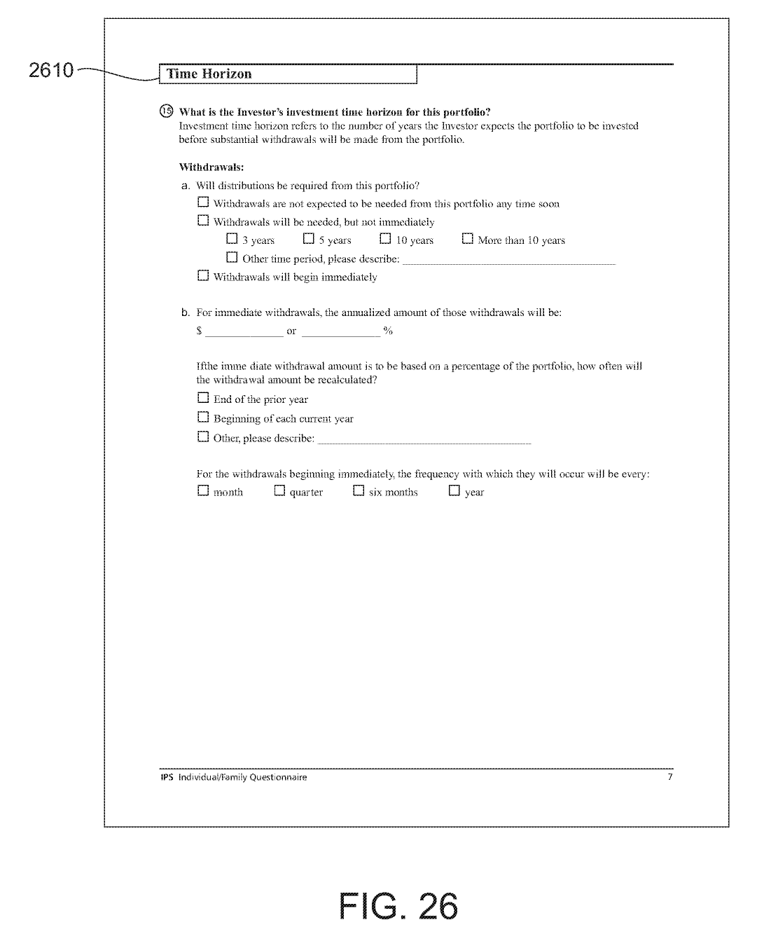

An exemplary investment objective questionnaire 2610 is shown in FIG. 26. In the current embodiment, the time horizon questionnaire 2610 asks questions related to when the client is planning to make withdrawals from the investments. In alternative embodiments, this questionnaire also may be used to describe the time over which a client wants to achieve their goals. If there will be specific uses for parts of the portfolio at a specific time, there may be a place to identify them on this questionnaire. A separate time horizon may be identified for each goal in this questionnaire.

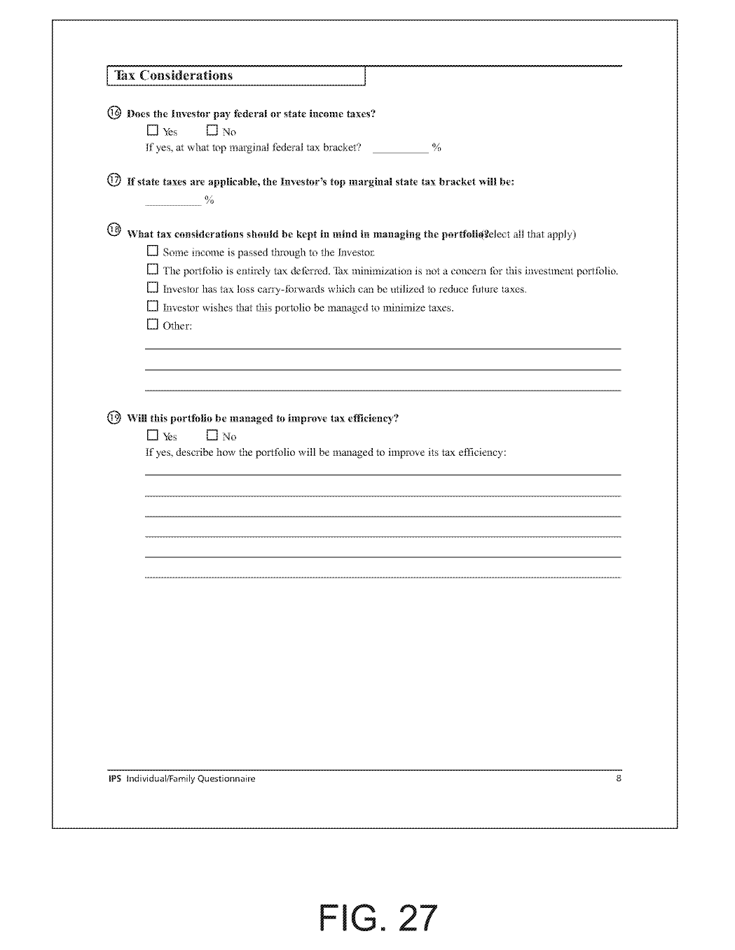

An exemplary tax consideration questionnaire 2710 is shown in FIG. 27. In the current embodiment, this questionnaire is designed to help describe the tax status of the client. Taxable portfolios include trusts and individual accounts (for which current taxes are due). The marginal tax bracket of the client may be identified. If the client is subject to alternative minimum tax (AMT), it may also be mentioned. Tax deferred accounts include IRA's, retirement accounts and annuities. If the client is a not-for-profit organization, the user may state what type it is and whether there are any restrictions or mandatory distribution requirements to maintain tax status. The description of the investment strategy for placement of certain asset classes in which type of taxable account may also be discussed in this questionnaire. In the current embodiment, the questionnaire also poses questions about whether the client is a taxable one, the amount of the portfolio that is tax-deferred and how important tax avoidance or minimization is to the client.

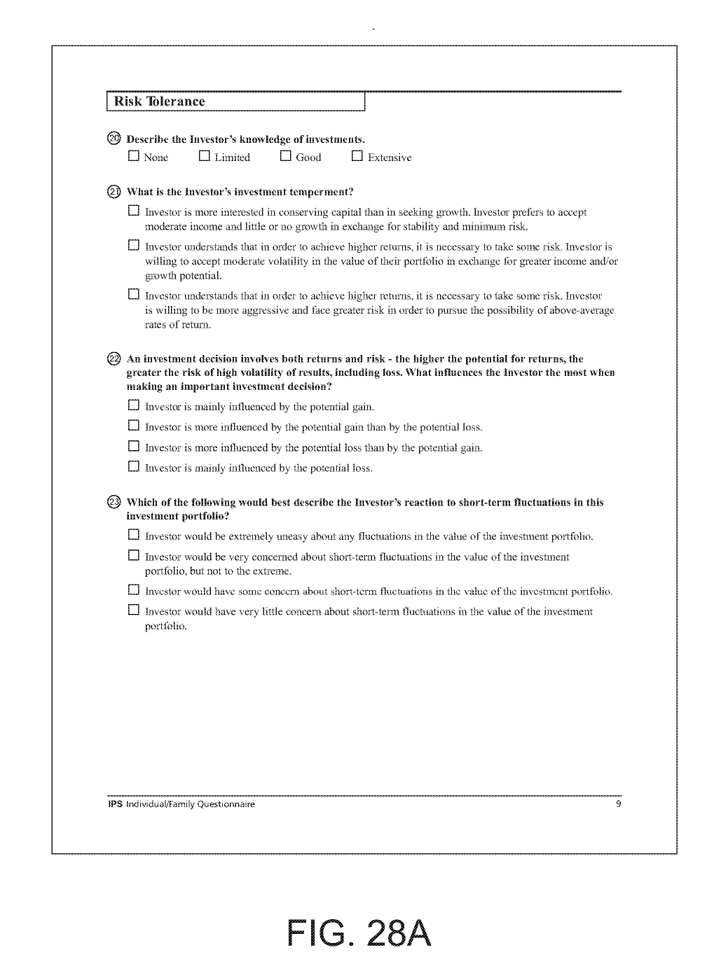

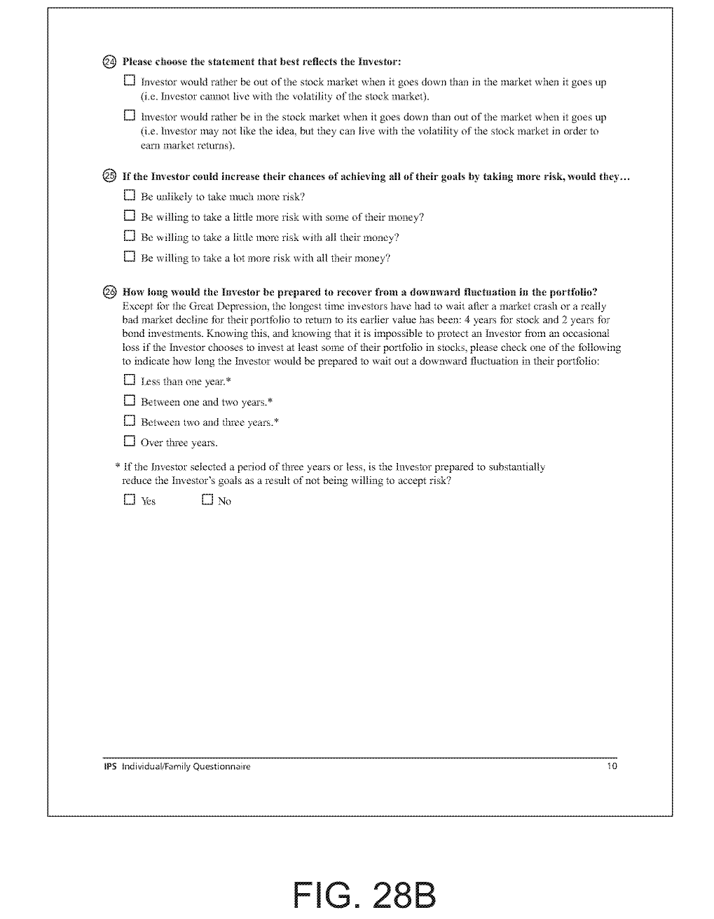

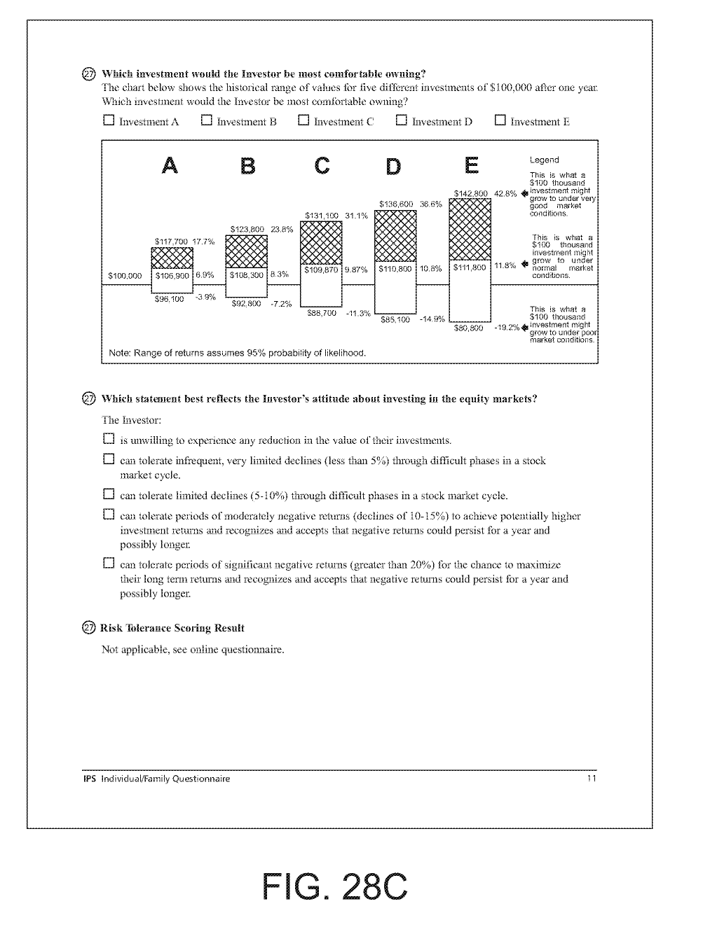

An exemplary risk tolerance questionnaire 2810 is shown in FIGS. 28A, 28B and 28C. In the current embodiment, the questionnaire attempts to identify the client's willingness to tolerate negative news. By use of questionnaires or from a discussion between the advisor and the client, the user attempts to clearly state what downside volatility a client agrees to live with. If bad times come, the advisor will be able to point to this section to verify the client's agreement to be patient.

For individual clients, risk tolerance is more of an educational issue, because if they are going to need a 10% return to attain their goals, the client is likely going to need to accept the risk that comes along with it—or adjust their goals. This section explores the clients' propensity for accepting volatility of their portfolio and by having the client provide the advisor with answers to these questions, the advisor can get a better feel for their risk tolerance. In alternative embodiments, the advisor may enter their own risk tolerance questionnaire or scoring system.

In the current embodiment, the system automatically computes a risk tolerance class or risk grade based upon the answers to the risk tolerance questions. The risk tolerance class is not shown in the printed questionnaire, but once the information is entered into the system, it will be shown in the risk tolerance interface. A user can, if desired, override the calculation of risk tolerance. The risk tolerance class or risk grade may provide a guide for a user to select an asset allocation model.

The determination of risk tolerance class is achieved by numerically evaluating the answers to the risk tolerance questions and then performing an addition of the values. Depending upon the sum of the values, a client is classified into one of several difference risk tolerance classes from “conservative” to “aggressive.” A user can elect to ignore or delete the risk tolerance class recommended by the system if desired.

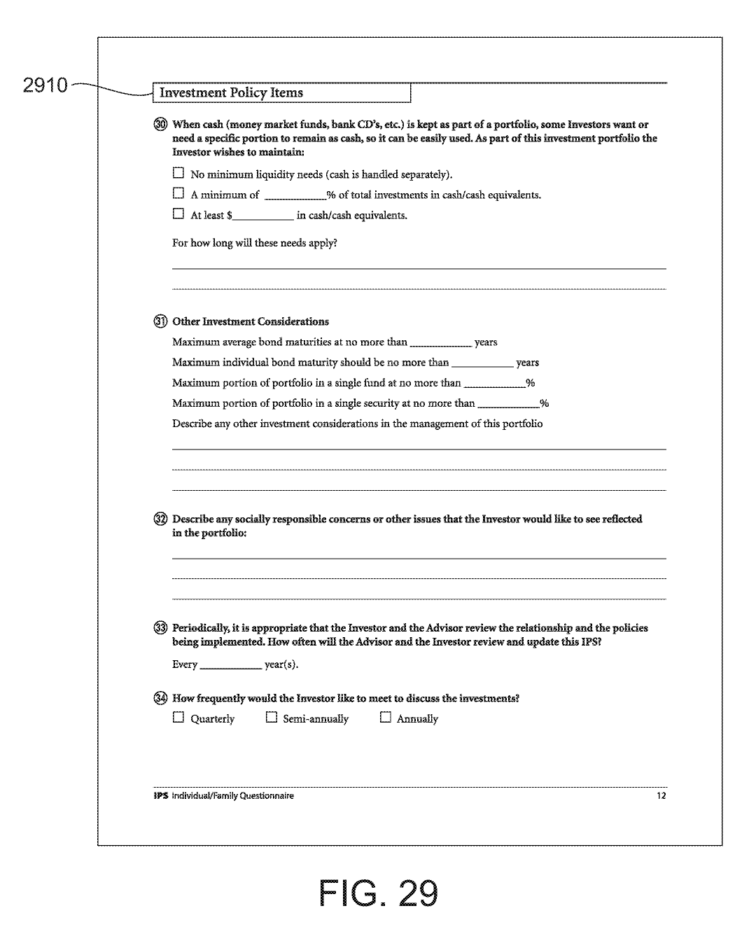

An exemplary Investment Policy Items questionnaire 2910 is shown in FIG. 29. This questionnaire helps ascertain how the portfolio will be held. In the current embodiment, the questionnaire poses questions about whether the client needs income or if the funds are being held for a specific need. In the current embodiment, this questionnaire also discusses the advisor's issues and policies. If the client has any specific need, a separate paragraph may be included to discuss how to deal with each need.

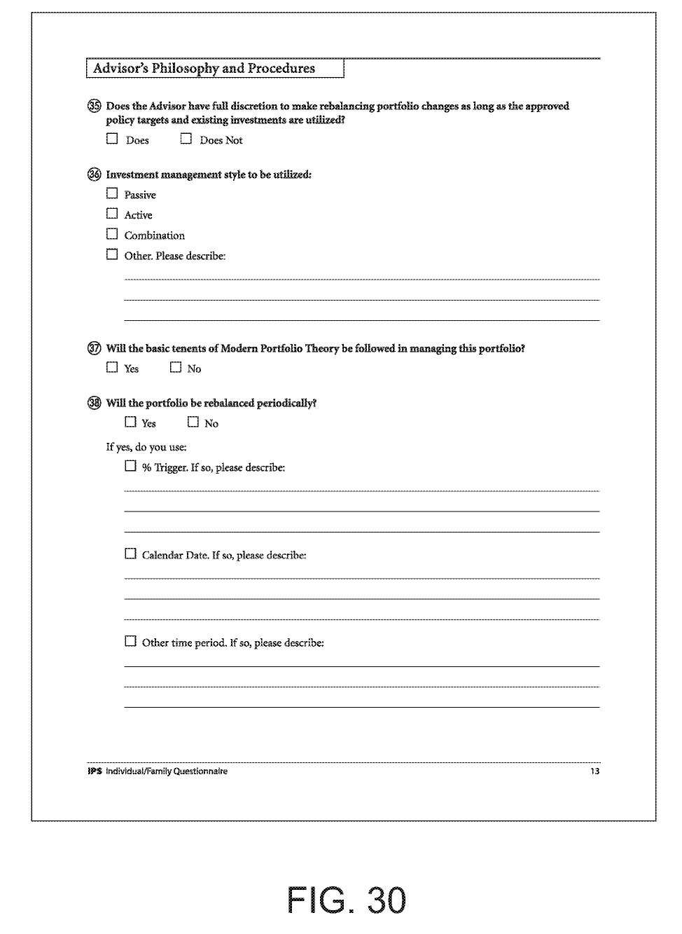

An exemplary Advisor's Philosophy and Procedures questionnaire 3010 is shown in FIG. 30. In the current embodiment, this questionnaire asks the client to describe how frequently or on what basis the portfolio will be rebalanced—daily, monthly, quarterly, semi-annually or annually—or based on some amount of over- or under-weighting (a percentage change from the target allocation) or some other method. This questionnaire may also ask questions about the advisor's philosophy and procedures. In one embodiment, the advisor may use this portion of the questionnaire to detail his or her style and make sure that the client agrees with that style. Generally, the client's answers to these questions ensure that the user and the client have a mutual understanding regarding various investment policies and advisor procedures to be implemented by the advisor while managing the client's investments.

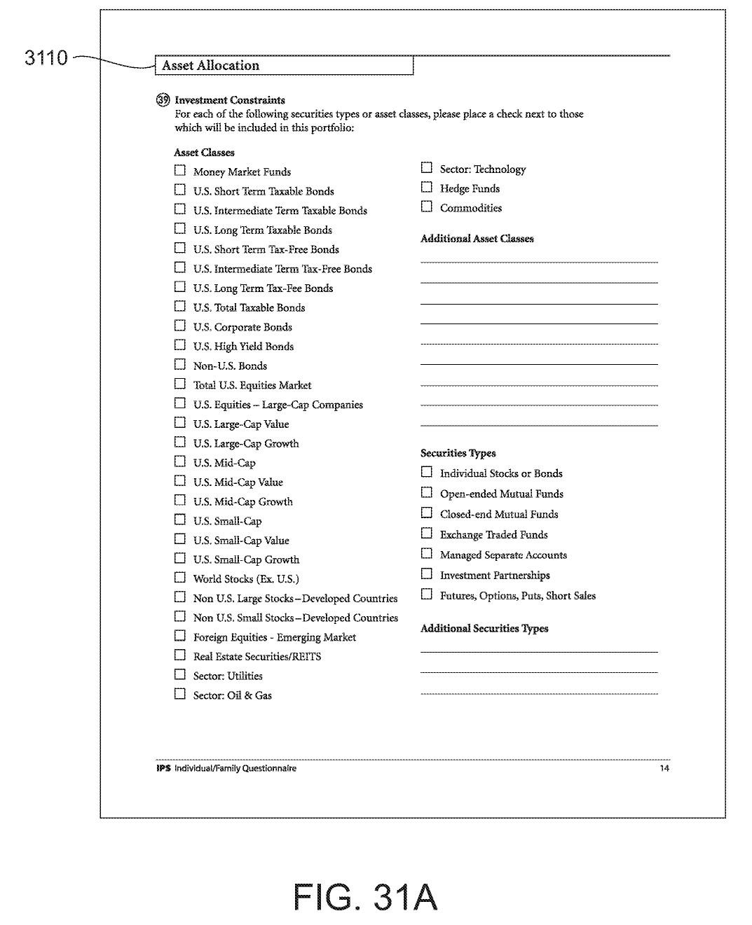

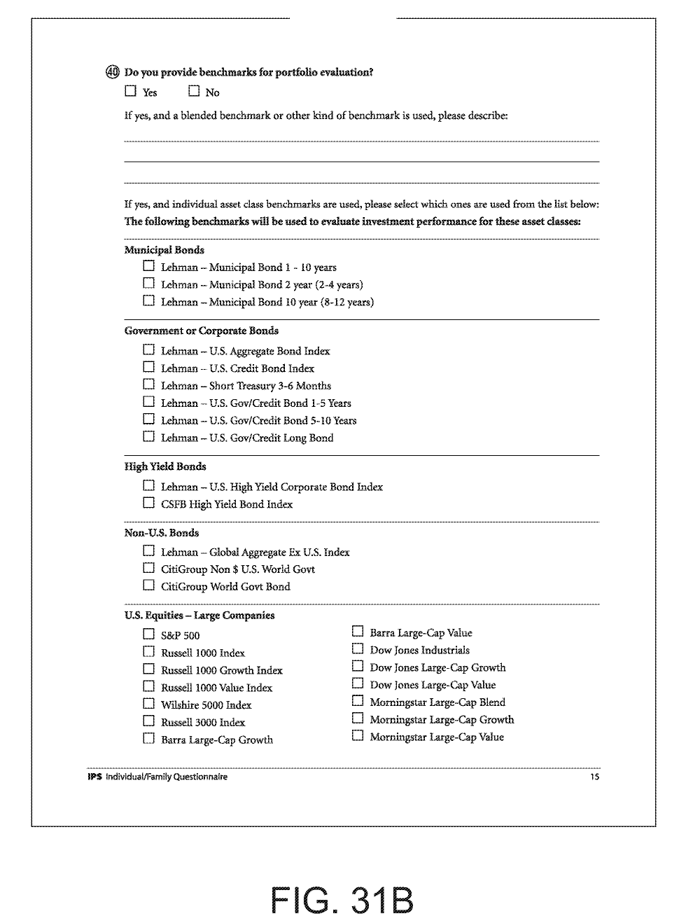

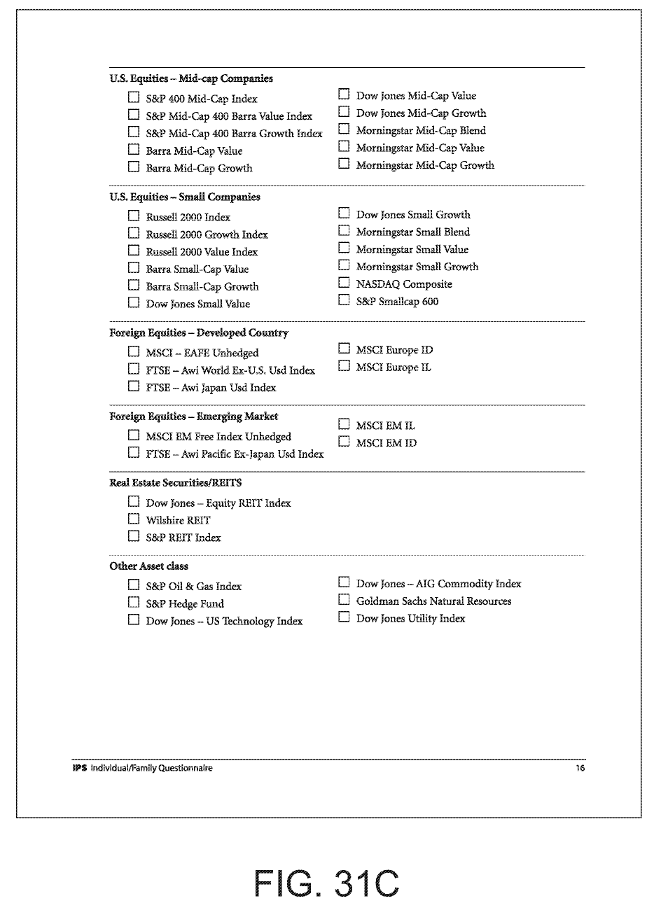

An exemplary Asset Allocation questionnaire 3110 is shown in FIGS. 31A, 31B, and 31C. In the current embodiment, this questionnaire asks the client to identify the permissible and non-permitted assets. Restrictions may be identified here. For example, can securities be pledged or hypothecated? Are there specific selection standards? If the client will not allow a specific investment or type, indicate that it is the client's decision and document why.

The interface shown in FIG. 31B enables a user to provide benchmarks for the evaluation of the portfolio. For example, municipal bond performance could be measured against the return for Lehman Brothers Municipal Bonds. High yield bonds could be measured against the Credit Suisse First Boston (CSFB) high yield bond index. Several different benchmarks are provided in drop down menus. A user could also enter text describing the method to be used by the advisor evaluating the portfolio performance.

The questionnaires listed above are merely exemplary and additional, fewer, or different questions or questionnaire topics or may be implemented.

3. Asset Allocation Model

The current embodiment of the system has approximately thirty unique asset classes, each with its own unique data points. Each asset class has its own unique data series, collected about its performance over a similar period of time. Primary investment data consists of investment returns and investment risk, as measured by standard deviation. Each asset class has a statistical correlation to every other asset class. The extent which one asset class behaves similarly or differently than another asset class determines the degree to which the two are correlated. The combination of all these individual correlation pairings is known as a correlation matrix.

Every asset allocation model is made up of one or more asset classes in a unique combination. By utilizing the risk and return data and the particular proportional weighting of each of the asset classes making up a particular asset allocation model and in consideration of the correlation matrix of those specific asset classes, the system may determine an expected rate of return and risk level for the portfolio as a whole. If the mix of asset classes within the asset allocation model changes, then the calculated portfolio risk and return data will generally also change.

The user may select an asset allocation model to be incorporated into the IPS. The list of available asset allocation models includes at least: 1) the system provided basic models; 2) any administrator created and approved models, as discussed above; or 3) given proper administrative rights, modified existing models with new names. In the current embodiment of the standard version of the system, the models available are the ones provided by the system. Each licensee (the administrator or general users assigned such rights) may create their own models. All users under one license will share in and have access to the same models. Models belong to the license, not to any single user. Users under a different license will have different models to which they have access, depending on the models created under that separate license.

The list of asset allocation models may be sorted by any column. The details of any of the listed models may be viewed or edited. A particular asset allocation model may be selected by selecting a “Use for this Client” link in an Actions column. In the current embodiment, selecting the “Use for this client” link will insert the information about the asset allocation model in the IPS and move a user on to the next step in the IPS creation process. A person of ordinary skill in the art would understand how to create an interface for selection of an asset allocation model.

If a user has already selected an asset allocation model, a chart of the selected asset allocation model along with its asset class breakdown will be available instead of the list of asset allocation models. The user may then choose to use the depicted model, modify the model, or go back to the list to select a different model or continue. If the chart is edited, the user is taken to the screen shown in FIG. 18 for the creation of a new asset allocation model. The models may be modified at the user or account level. For example, a user with appropriate permissions may modify the allocations of asset classes, or override individual statistics of each class. These modifications may be made for individual clients or on an account wide basis, effecting all clients for a specific advisor or group of advisors. The ability to override an asset class may be set for each client as well, so that once a client chooses an asset allocation it is not changed by an account wide modification.

4. IPS Generator

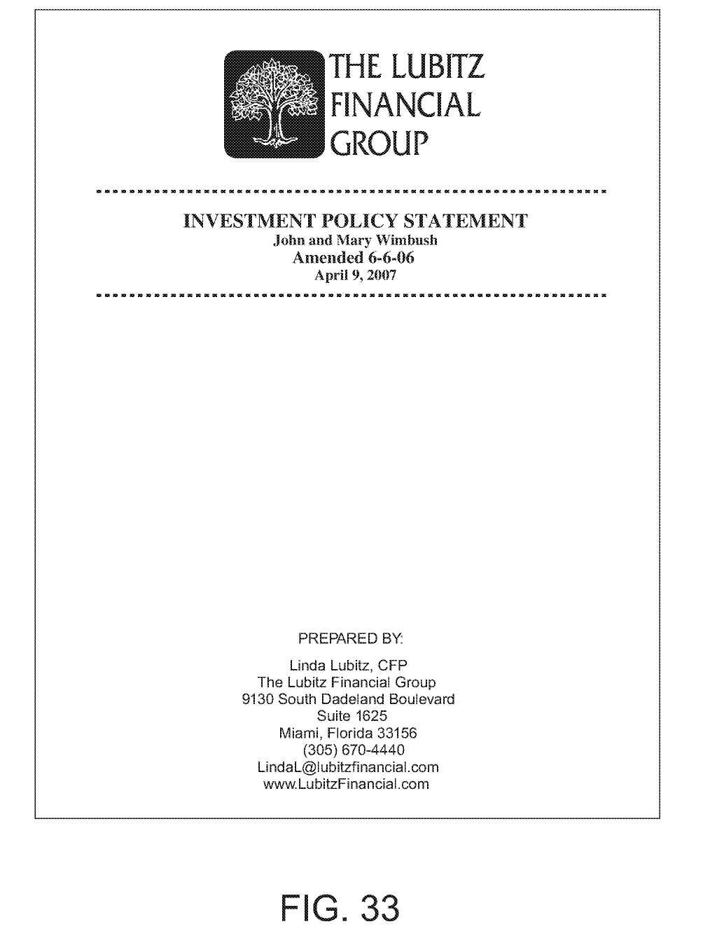

After the completion of the questionnaire and selection of the asset allocation model, the IPS generator produces an IPS. In one embodiment, the IPS may be printed via the interface shown in FIG. 33. A person of ordinary skill in the art would understand how to implement fewer, different, or additional IPS generator features. In the current embodiment, the questionnaire responses are merged with an IPS template into an HTML document. The HTML document is then converted using a stylesheet transformation into an XML format which can be turned into a PDF.

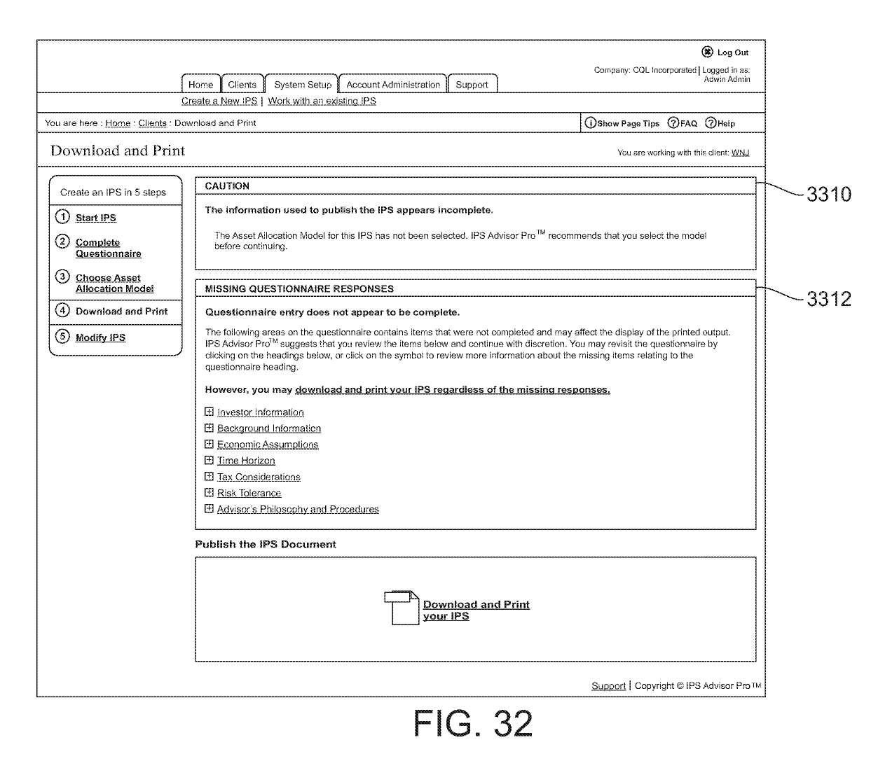

The Download and Print interface 3310, shown in FIG. 32 provides a link to download and print the IPS. In the current embodiment, this interface may also identify any errors or whether any answers to the questionnaire are incomplete in an error message 3312. In the current embodiment, the IPS may be downloaded regardless of if there is an error.

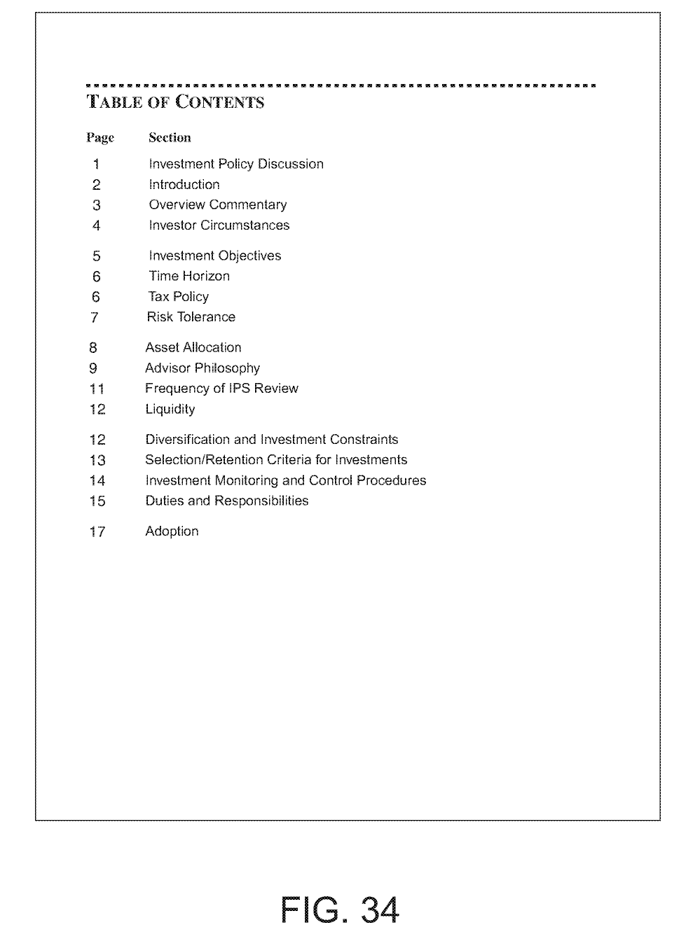

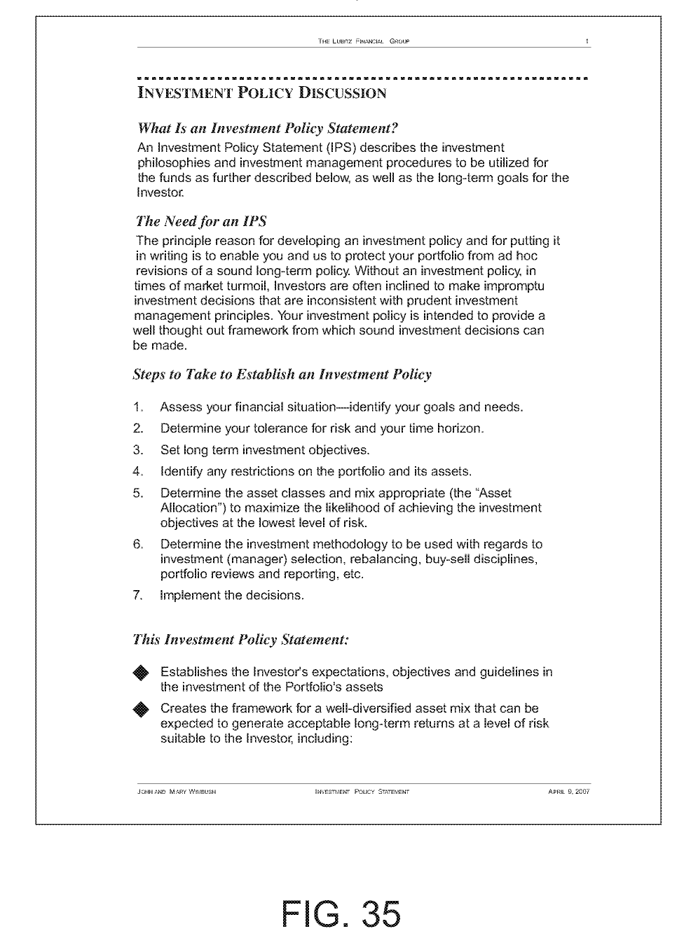

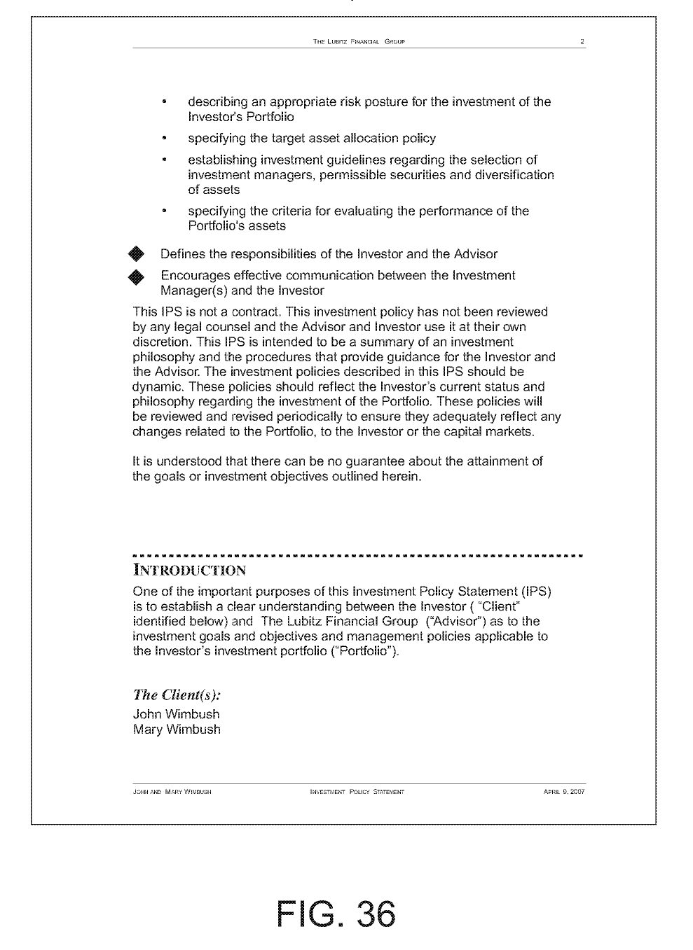

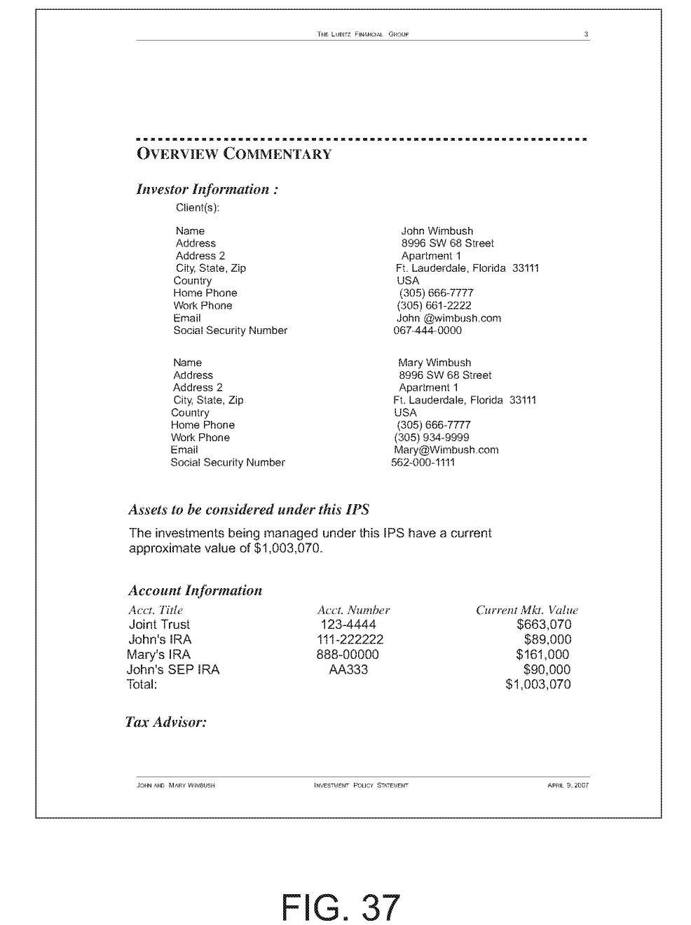

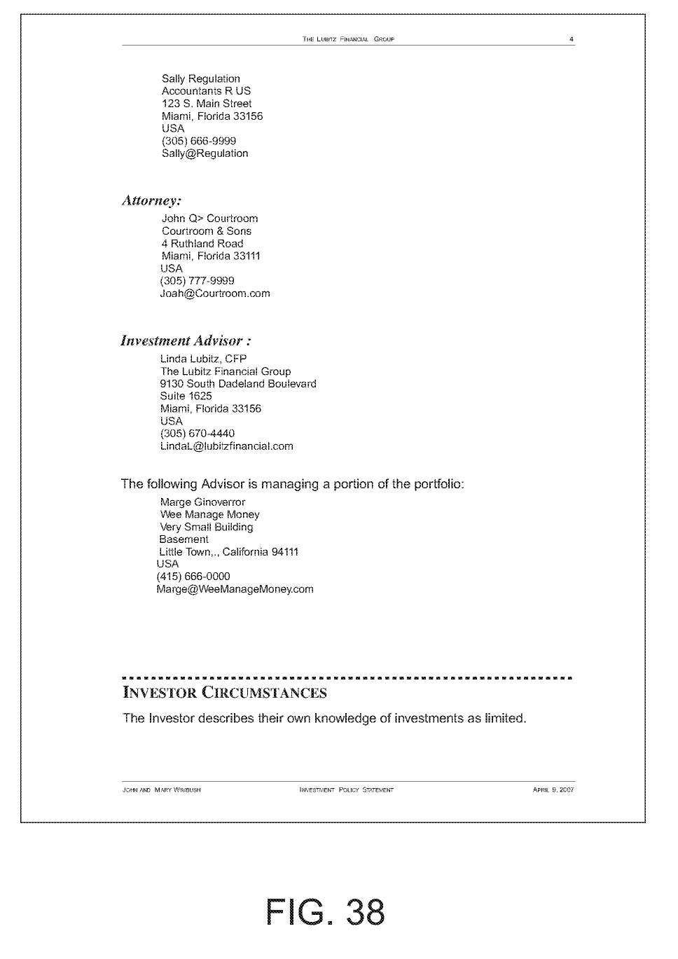

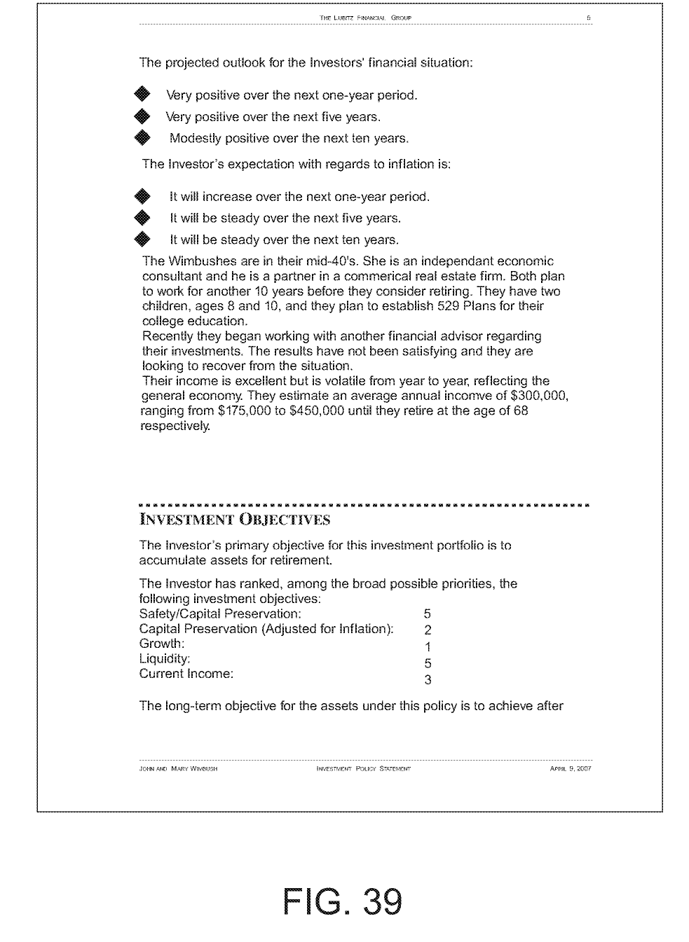

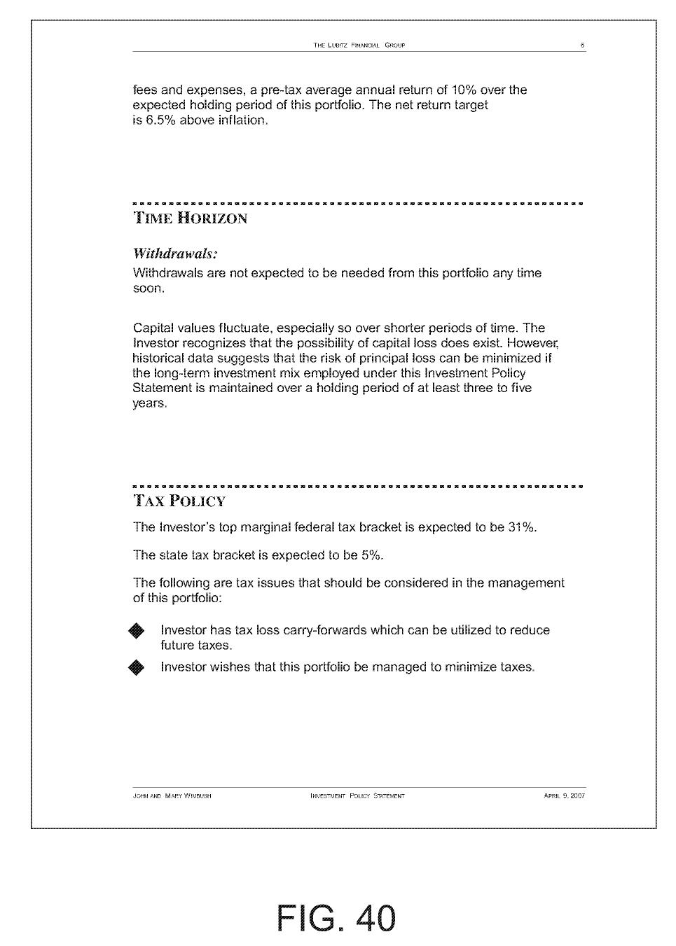

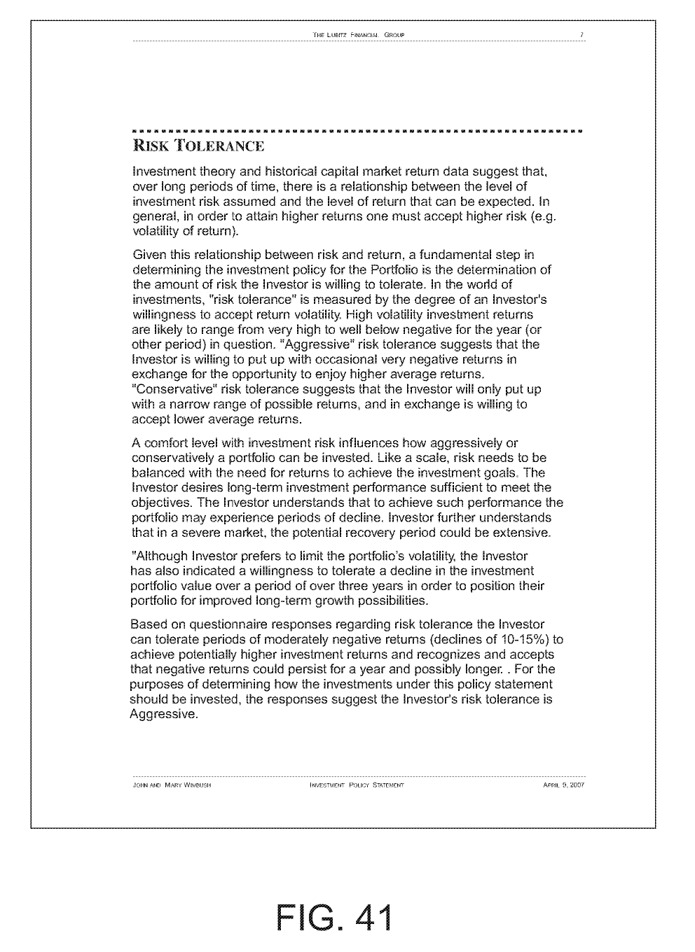

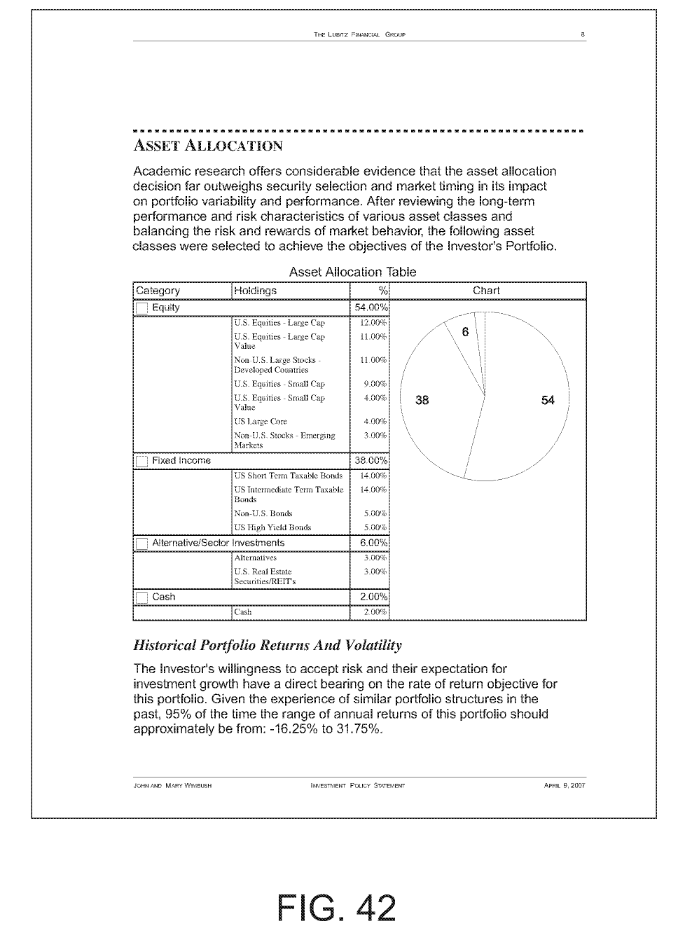

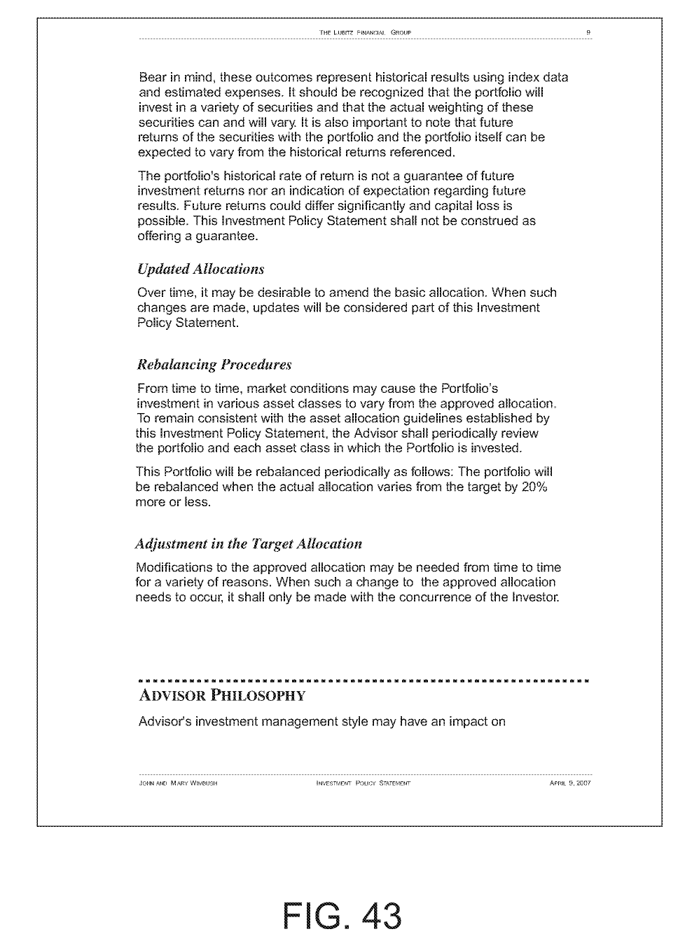

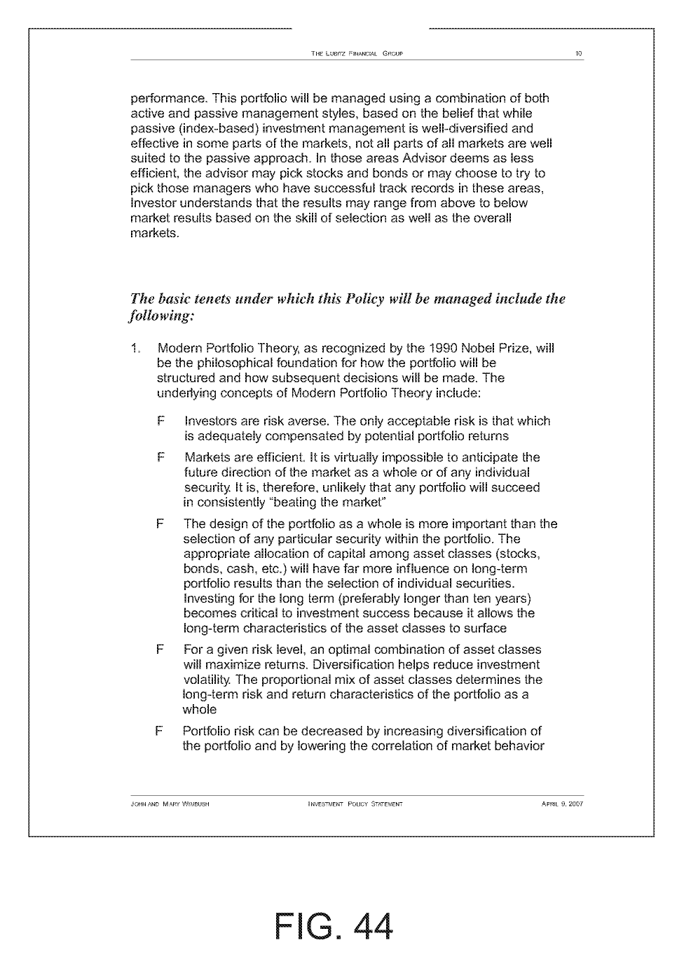

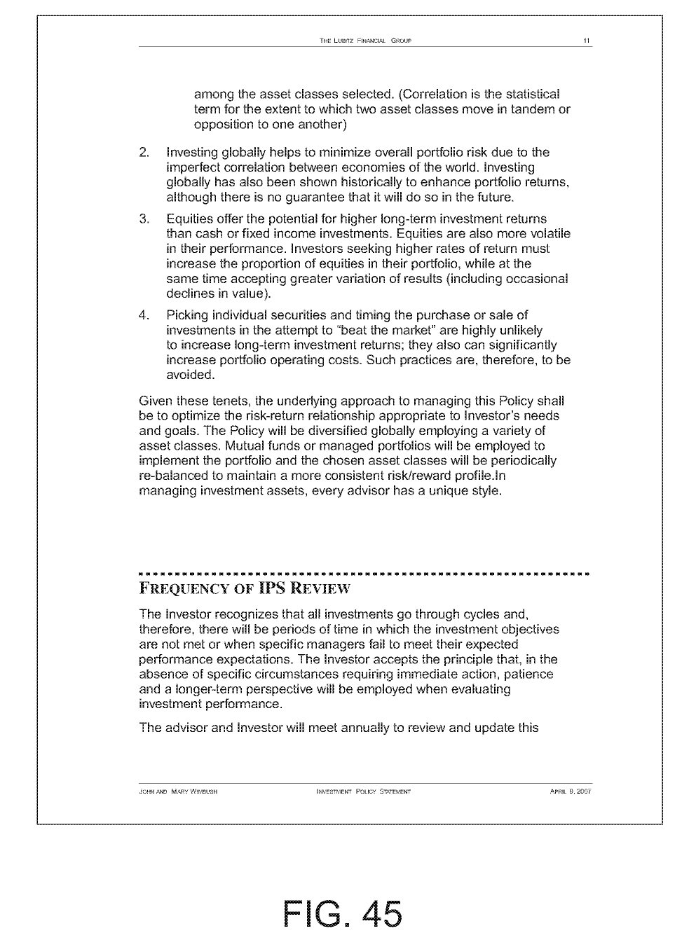

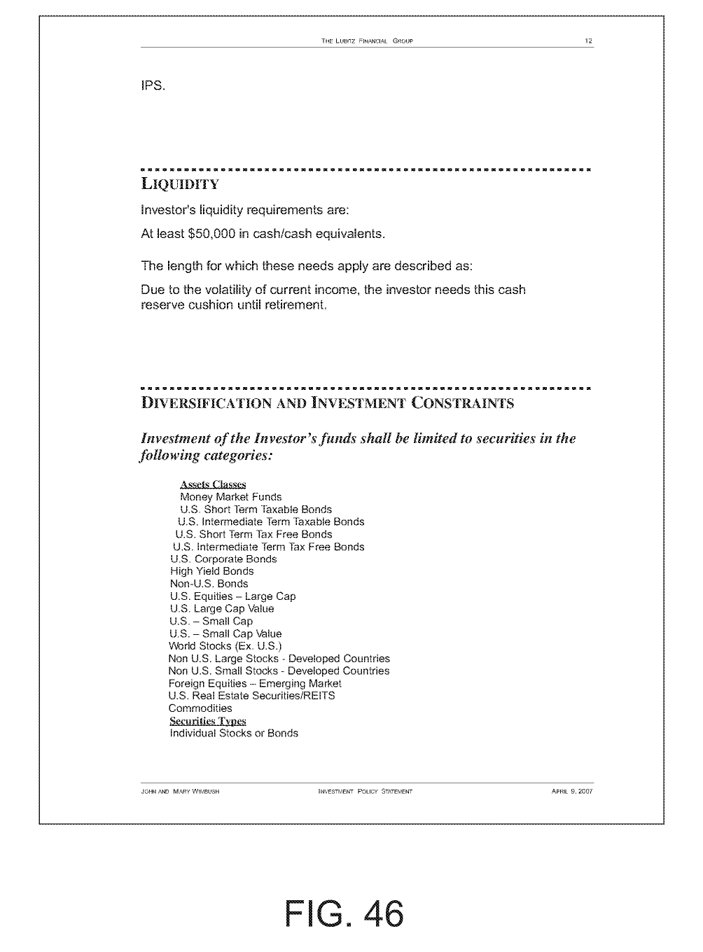

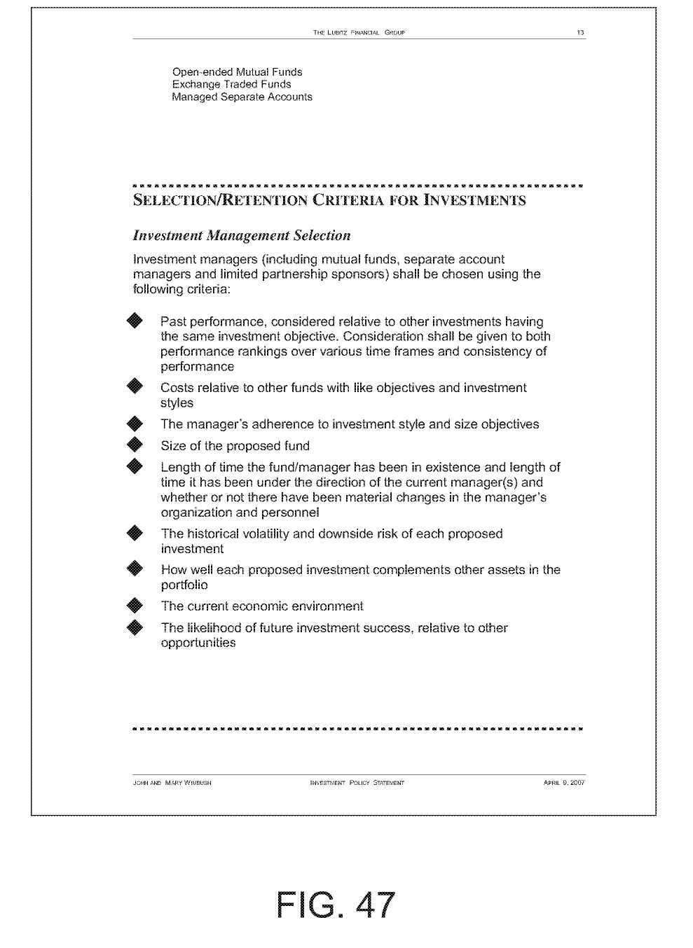

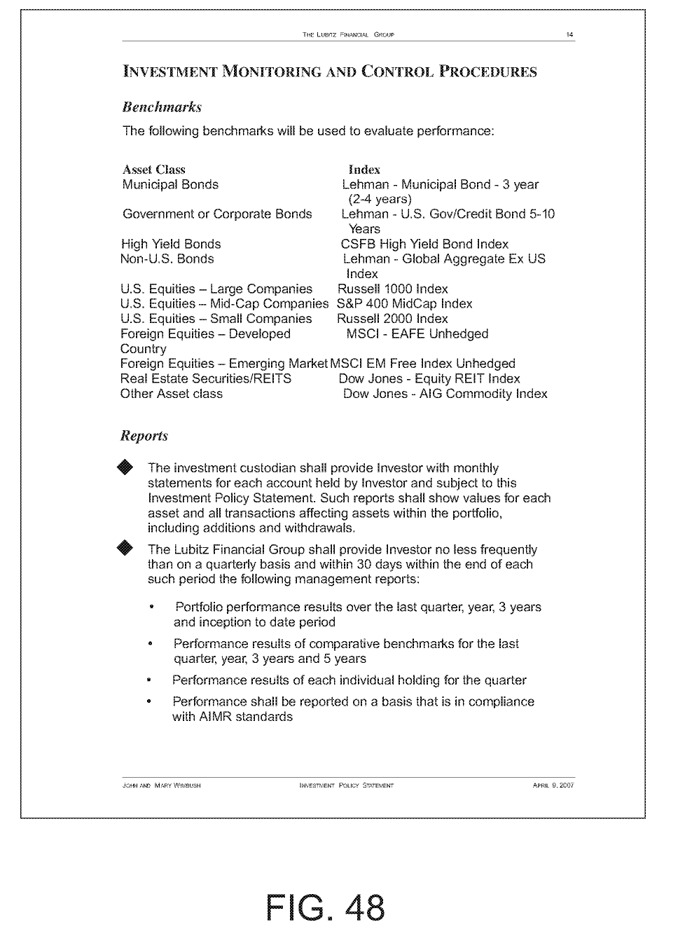

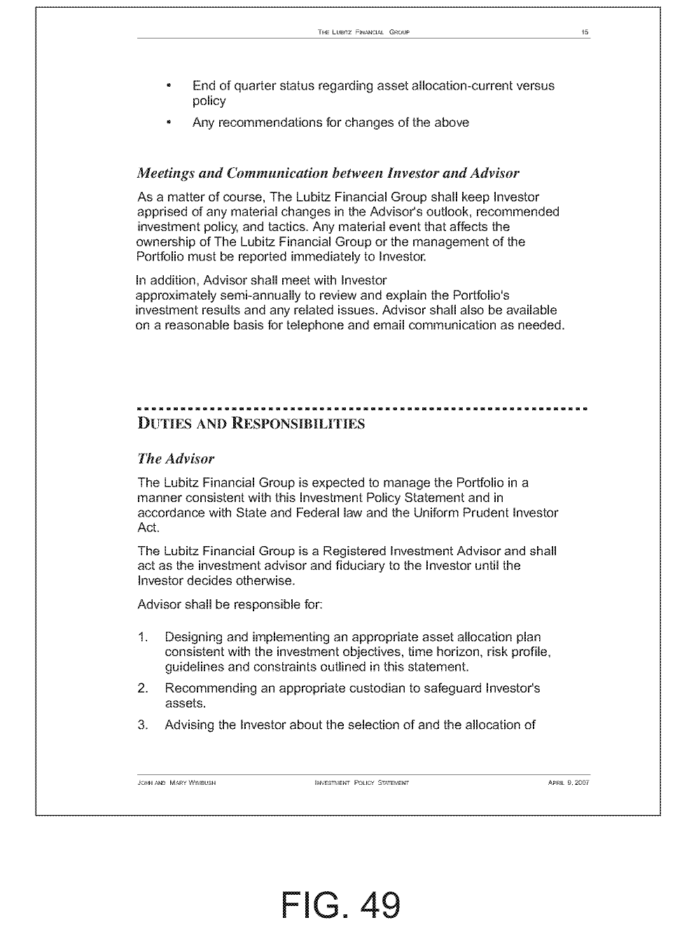

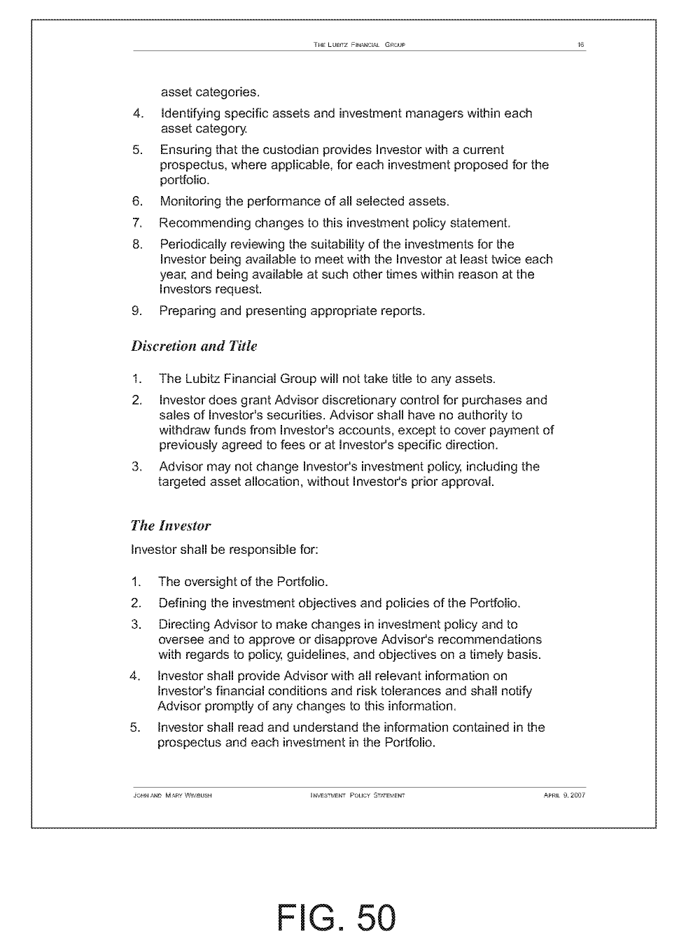

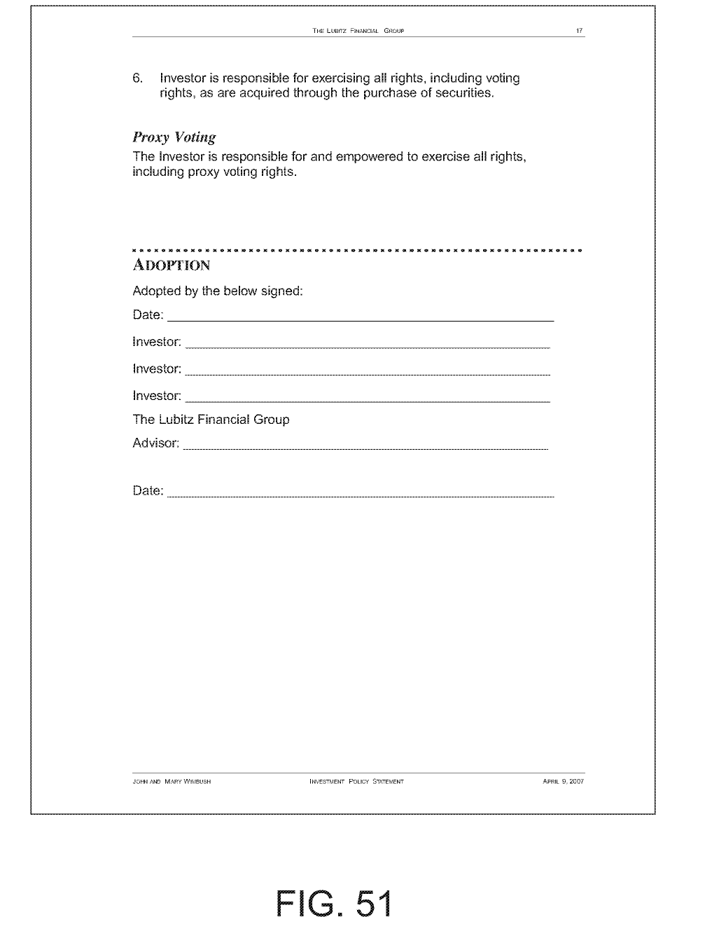

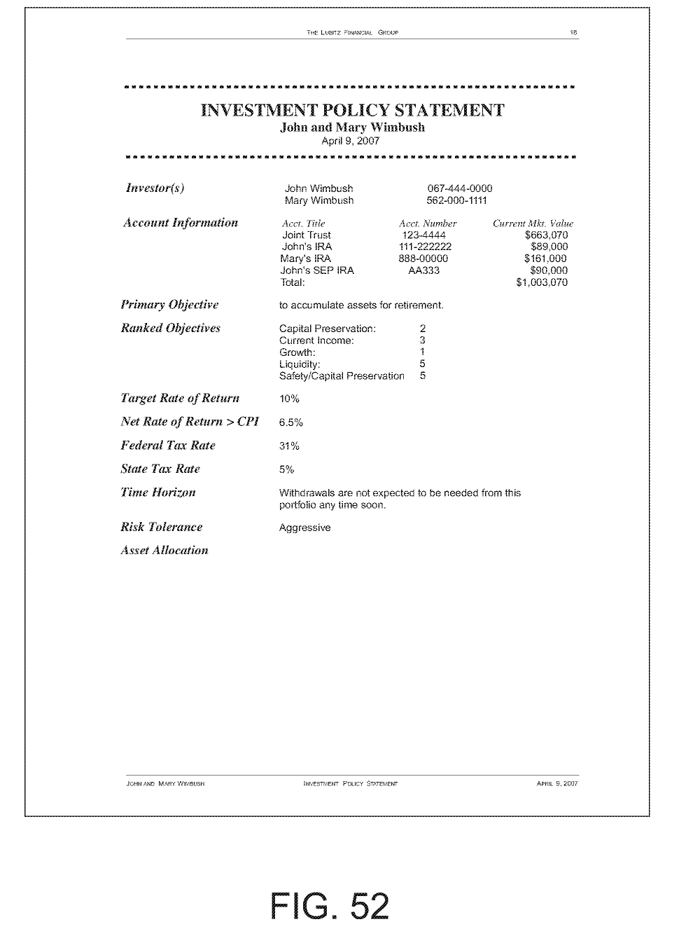

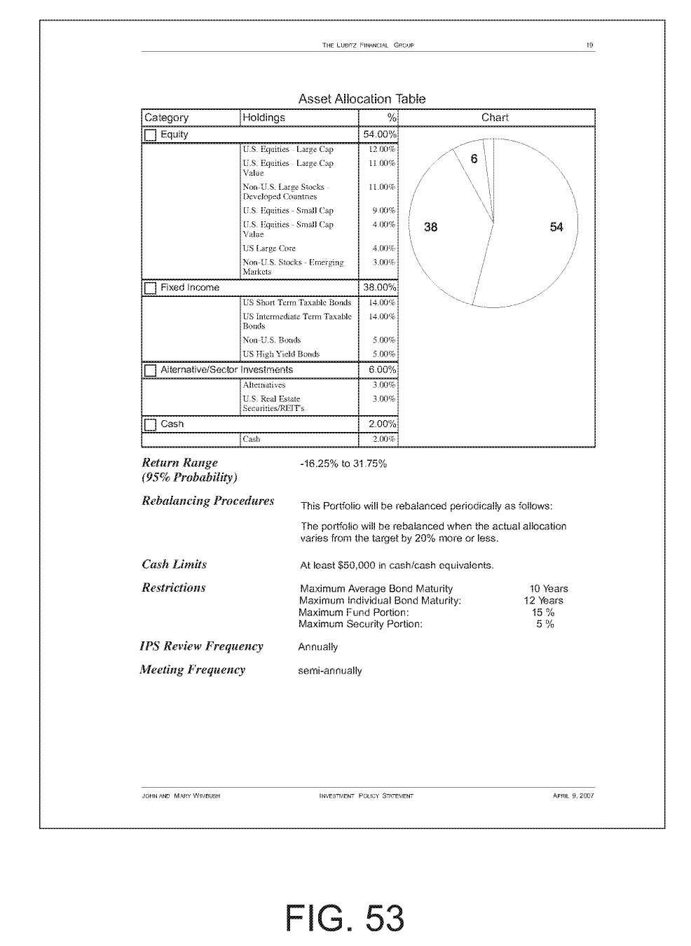

FIGS. 33-53 show a generic IPS as created by the system described herein. This IPS is merely exemplary and is not discussed in detail because the exact details of a specific IPS do not merit discussion.

All of the interfaces described above in conjunction with the IPS system may be implemented with less, different, or additional features or may be implemented with a different layout. A person of ordinary skill in the art would understand how to program these interfaces.

III. Method

A flow chart illustrating the general method for creation of an IPS from the system's perspective is shown in FIG. 1B. As noted above, the method for creating an IPS from the system's perspective generally includes the steps of 1) receiving an IPS template selection; 2) communicating an IPS questionnaire tailored to the IPS template selection; 3) receiving responses to an IPS questionnaire; 4) receiving an asset allocation model selection; 5) generating an IPS based on the questionnaire responses that incorporates the asset allocation model; and 6) receiving revisions to the IPS based on client feedback, if necessary. In the current embodiment, there is an optional step of receiving revisions to the IPS based on client feedback. Each of these steps will be discussed in more detail below.

In the current embodiment, creation of an IPS begins with the system receiving an indication about the starting point or base template. Typically, this template will have been previously prepared by an investment advisor to reflect his or her style of investment management. The template incorporates any stock investment policy language for the IPS and also includes response dependent fields. In the current embodiment, each IPS template may have different versions depending on the IPS type. For example, in the current embodiment there is a separate IPS template version for each of the following IPS template types: individual/family, a trust, a charitable trust, an endowment/foundation, a pension plan, a self-directed 401(k) plan, a profit sharing plan, a life and an insurance policy. In alternative embodiments, there could be fewer, different, or additional template versions. In one embodiment, there are multiple template versions for each IPS template type. In this embodiment, a default IPS template may be associated with each IPS template type.

After the system has received an IPS template selection, the system communicates an IPS questionnaire to the user. In the current embodiment, the IPS questionnaire includes questions which assist in filling the response dependent fields in the IPS and creating a client profile.

After the system receives the responses to the questionnaire, the system will solicit and receive an asset allocation model selection. Finally, an IPS may be generated that uses the responses to the questionnaire to generate a client profile, fills the response dependent fields in the IPS and incorporates the asset allocation model selection into the IPS. The generated IPS may be printed or saved for either or both of the client's and user's records. Optionally, the advisor may review the IPS with the client to obtain feedback which may be used to revise the IPS. In the current embodiment, the application has a “PRO” and a “STANDARD” version. The standard version includes shorter templates and questionnaires.

III. Data Model

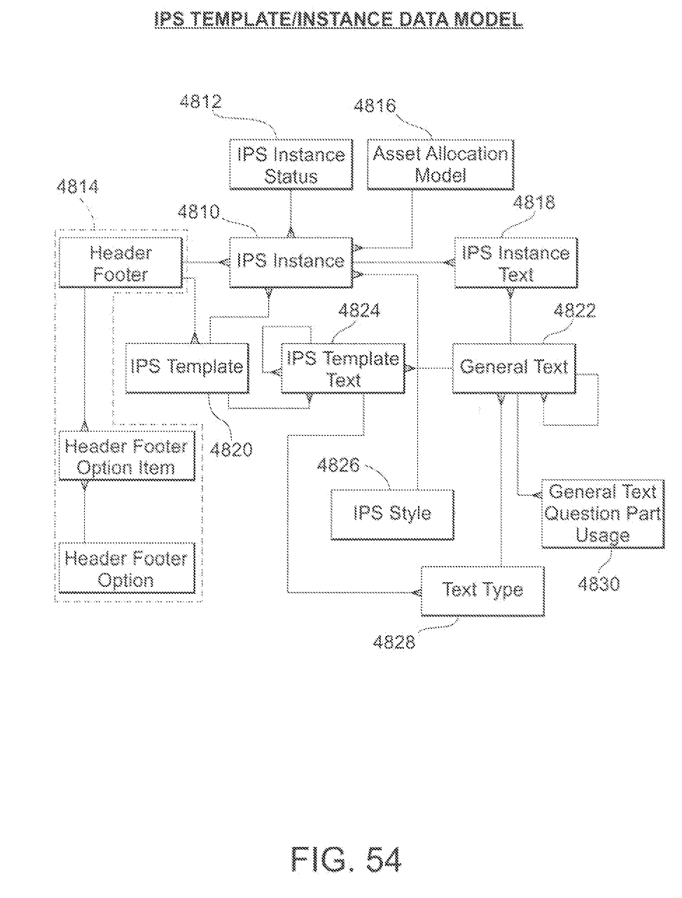

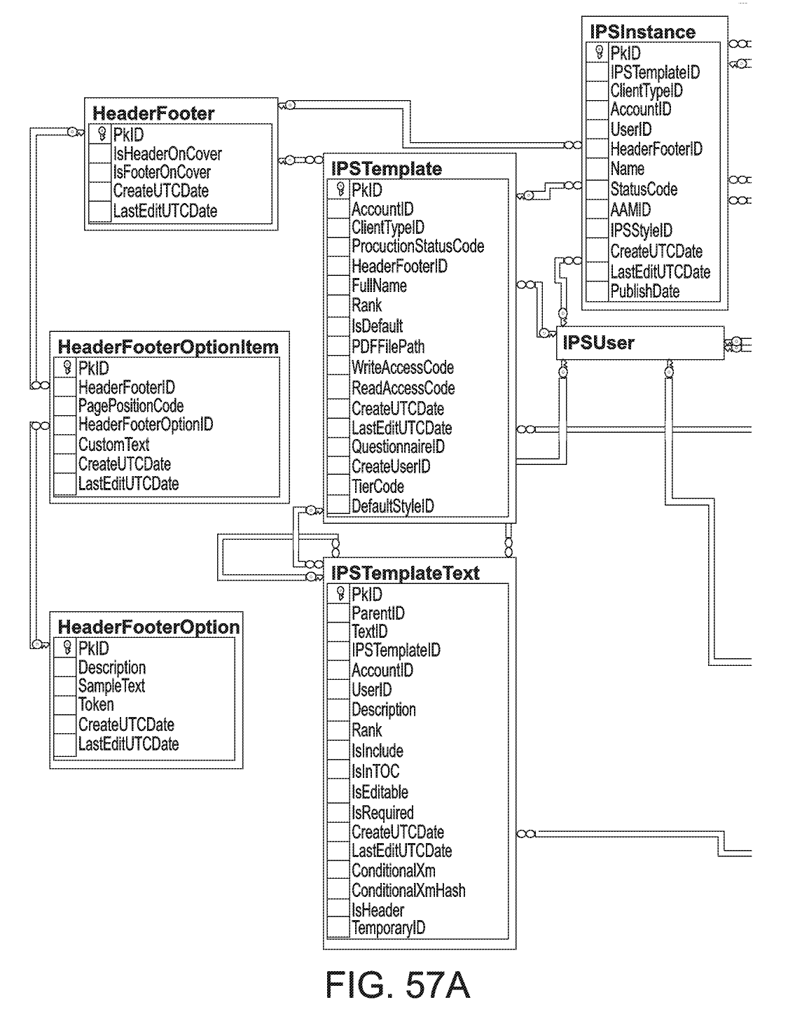

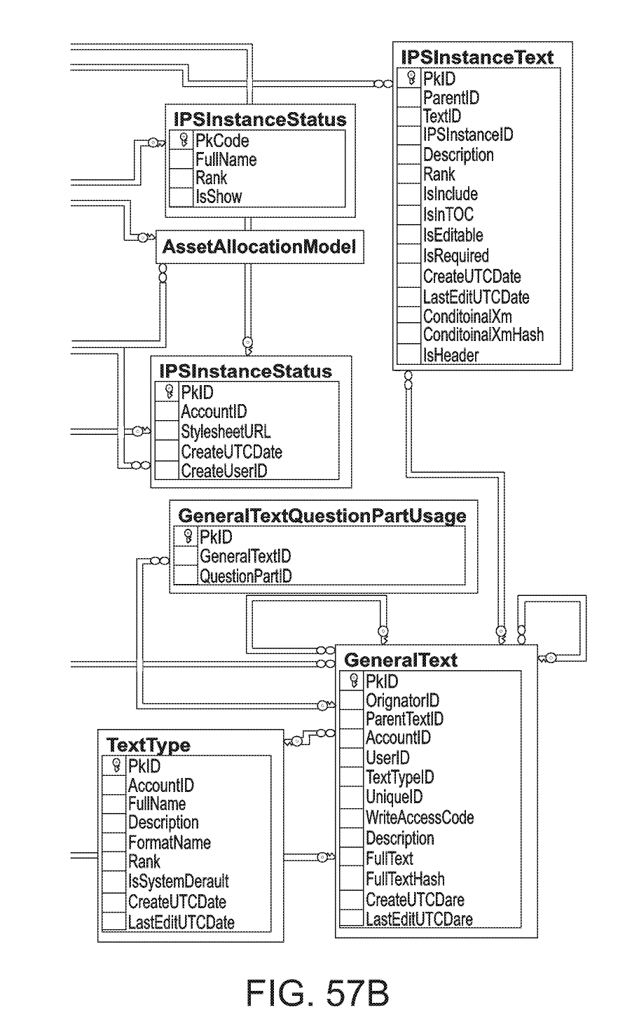

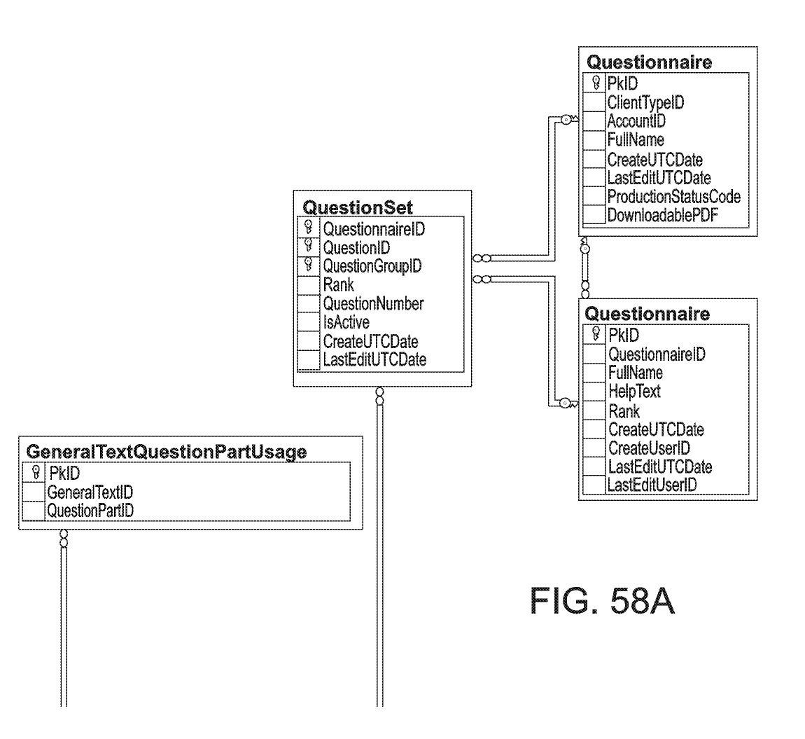

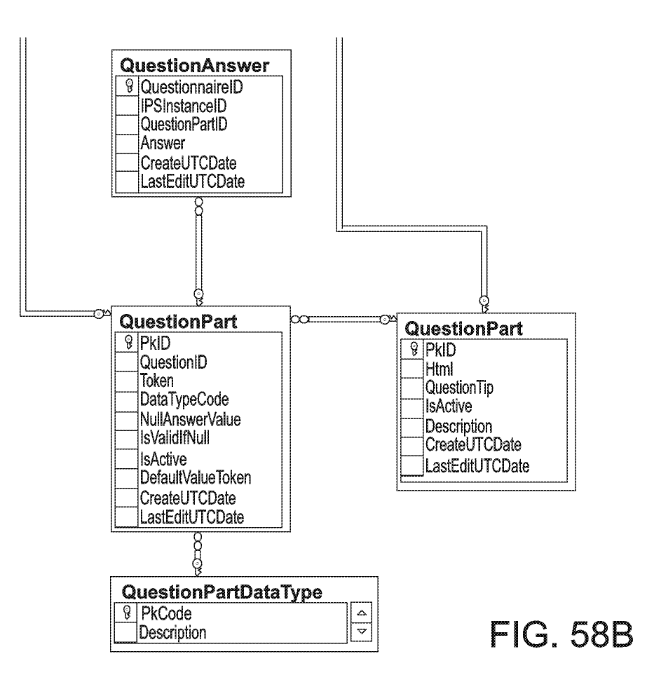

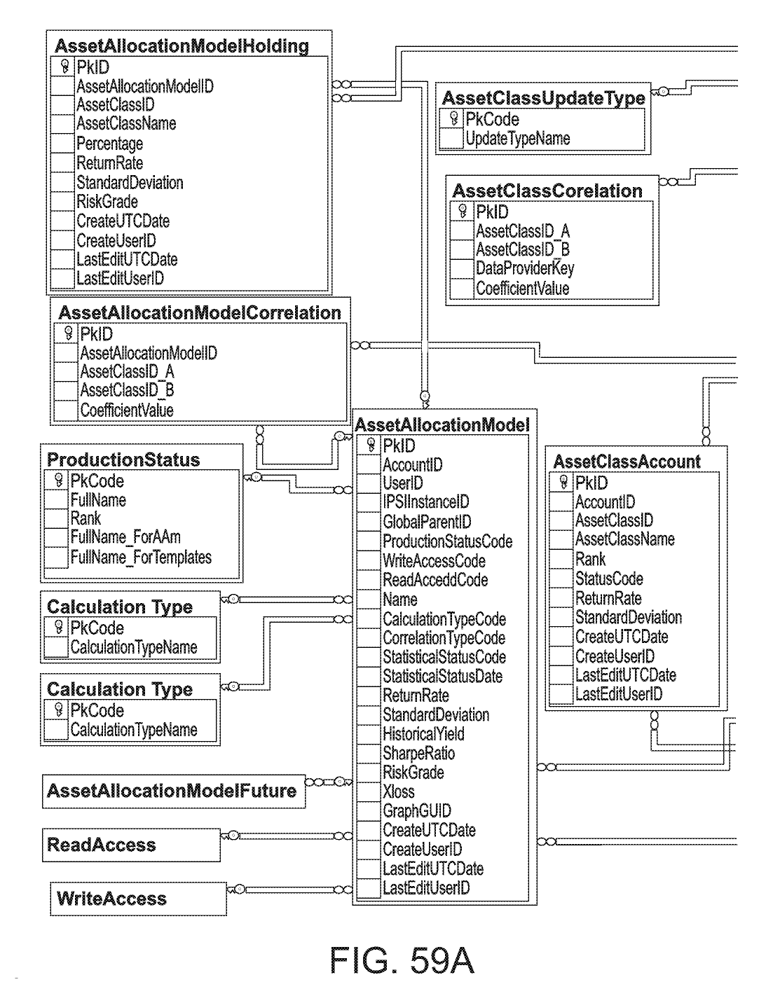

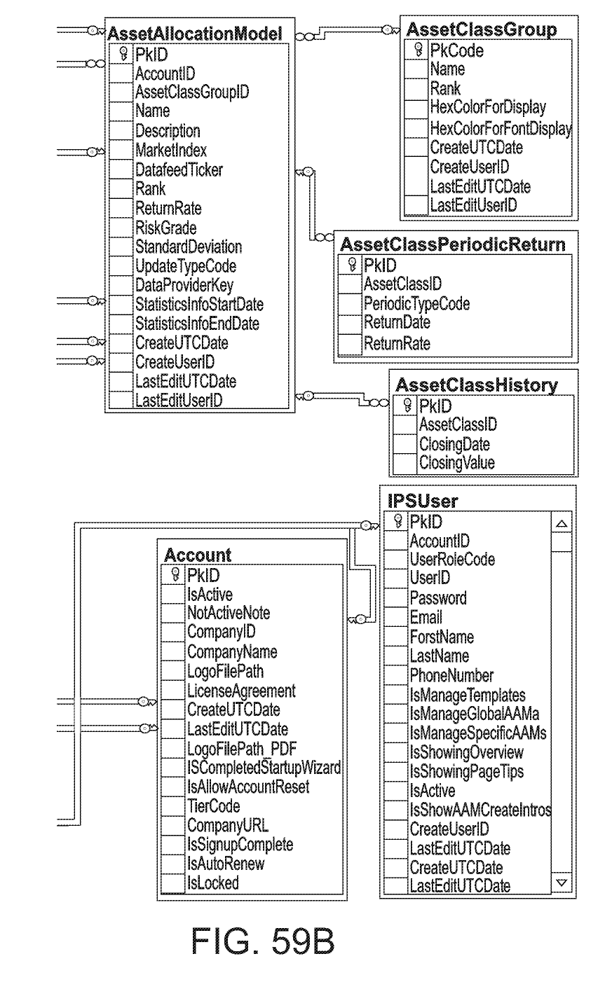

There are various data models which support the system. FIGS. 54-56 show exemplary general data models for the system. FIGS. 57-59 show exemplary detailed data models for the system. The data models are discussed with respect to the general data models below. The detailed data models are provided for completeness sake, but it should be understood that the data model could be implemented with different fields. The field names in the detailed data models are descriptive, but exemplary. PkID is used as a primary key in a majority of the tables, and the lines showing the relationships between the tables do not indicate which field is the primary key. A person of ordinary skill in the art would understand which of the fields is the primary keys to the linked table.

FIG. 54 shows a current embodiment of an IPS instance data model. An IPS instance 4810 represents a single IPS. The IPS instance status entity 4812 is a table that holds status codes and serves as a lookup table. A column in the IPSInstance entity flags whether or not the IPS is complete. Multiple IPS instance text entities 4818 may be associated with a single IPS instance. Each of the IPS instance text entities 4818 maps where and whether blocks of text, for example paragraphs or sections, appear within the IPS. In addition, the IPS text entities 4818 may control editability, visibility, and store any response dependency constraints. The IPS template 4820 indicates which IPS template is used for this particular IPS as well as any parameters associated with the use of this particular IPS template. Header footer entity 4814 includes data concerning the IPS header and footer. The asset allocation model entity 4816 includes a data representation of an asset allocation model associated with this IPS, for example, it may include a data representation of the asset allocation model shown in FIG. 12.

In the current embodiment, each of the IPS instance text entities 4818 is derived from several other entities. For example, in the current embodiment, each of the IPS instance text entities 4818 is derived from a general text entity 4822 that houses all of the individual blocks of text that appear either in a template or an instance. The general text entity 4822 also may be broken down into separate entities. For example, in the current embodiment, the general text entity 4822 is associated with one or more IPS template text entities 4824, a text type entity 4828, and a general text question part usage entity 4830.

IPS template text 4824 defines which sections and paragraphs exist for an IPS template and where those paragraphs appear in the IPS template. IPS style entity 4826 defines how the IPS instance is to be interpreted or transformed when the PDF of the IPS is created. For example, it may perform operations to transform the raw output for an IPS into an approved format or style.

Text type entity 4828 identifies the type of text such as “cover interface”, “overview commentary” or “Trustee 1 information”. It defines the types of text within general text table that identifies similarities with the general text.

General text question part usage entity 4830 is a system maintained table for tracking which question parts are used within the general text.

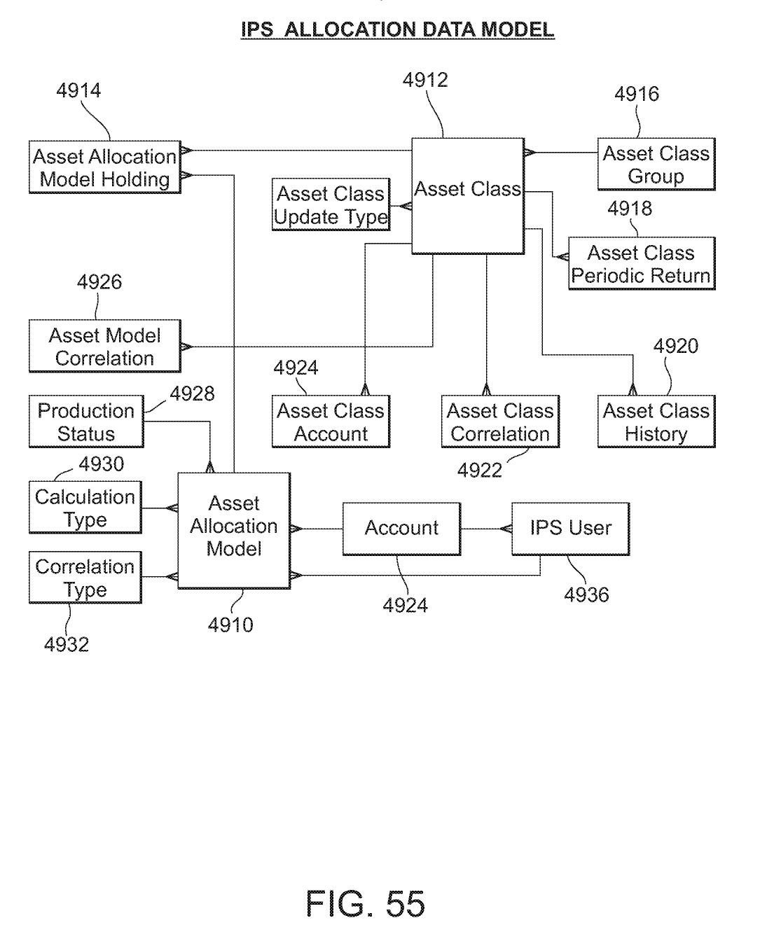

FIG. 55 shows the current embodiment of an IPS allocation data model. The asset allocation model entity 4910 identifies a specific allocation model. The current embodiment includes a summarization of the asset allocation model. Asset class entity 4912 identifies assets such as, for example, small cap, large cap, or commodity. It also includes a summary of statistical data for that class over a period of time, such as historical rate of return and historical deviation.

The asset allocation model holding entity 4914 maps asset classes to asset allocation models and percentages. Users may override these percentages and asset allocation classes. Additionally, a user may save an asset allocation model configuration. The asset class group 4916 includes major groupings of assets such as cash, equity, fixed income, and alternate/sector investments.

The asset class periodic return entity 4918 stores summarized historical return data. The asset class history entity 4920 stores the asset class history. The asset class correlation entity 4922 maintains a correlation coefficient value between two asset classes.

The asset class account entity 4924 maps and stores asset classes associated to an account. The asset class account entity 4924 includes override data concerning historical return and historical standard deviation. The asset model correlation entity 4926 includes override data of correlations between assets at the asset allocation level. Production Status 4928 contains status codes as to whether an asset allocation is ready to be used.

The calculation type entity 4930 defines how various statistics concerning the asset allocation model are calculated. For example, the calculation type entity 4930 may indicate whether data was derived automatically by the system or whether it was manually entered.

The correlation type entity 4932 defines when the statistics are automatically correlated. The account entity 4934 identifies the owner of the IPS. In one embodiment, the account entity 4934 may be used by the system for billing purposes. The IPS user entity 4936 identifies a specific user of the system.

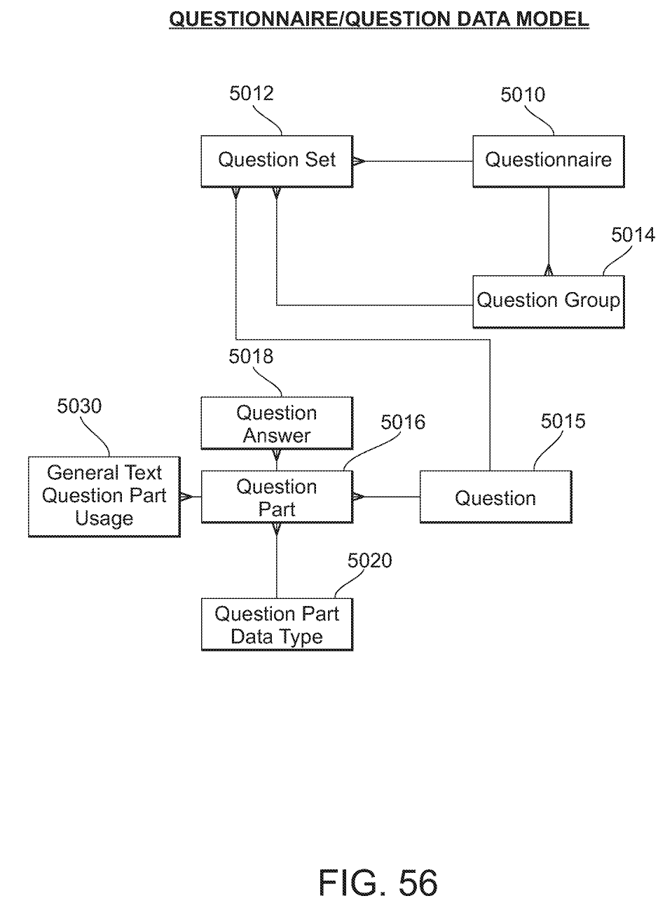

FIG. 56 shows the current embodiment of a questionnaire/question data model. In the current embodiment, the questionnaire entity 5010 includes the name of a group of questions. The question set entity 5012 combines individual questions into groups. It also specifies how they are arranged in a questionnaire. The question group entity 5014 is a group of similar questions. The question entity 5015 includes an actual question and any parameters for how it should be displayed. It also includes place holders that represent question parts. The question part entity 5016 describes the attributes of the place holder and whether it is valid if blank, what data type it is, and the name of the place holder that appears in 5015.

The question answer entity 5018 contains the user response to a question as presented through the questionnaire. The question part data type entity 5020 serves as mechanism to store allowable question part data types. Values such as text, money, date, decimal are normal.

The above description is of the current embodiments. Various alterations and changes can be made without departing from the spirit and broader aspects of the invention as defined in the appended claims, which are to be interpreted in accordance with the principles of patent law including the doctrine of equivalents. Any references to claim elements in the singular, for example, using the articles “a,” “an,” “the,” or “said,” is not to be construed as limiting the element to the singular.

The embodiments of the invention in which an exclusive property or privilege is claimed are defined as follows:

1. A system for creating an investment policy statement for a client comprising:
an investment policy statement template manager including an interface to create a plurality of investment policy statement templates, each template including a plurality of paragraphs related to investment policies, at least one paragraph including a response dependent field;
an investment policy questionnaire manager including an interface to display a plurality of investment policy questions and to receive a plurality of responses to said investment policy questions; and
an investment policy statement generator for generating said investment policy statement based at least in part on said responses to said investment policy questions, the investment policy statement including at least one of an investment objectives section, a time horizon section, a tax policy section, a risk tolerance section, an asset allocation section, an advisor philosophy section, diversification section and an investment constraints section.

2. The system of claim 1 comprising:
an asset allocation manager for at least one of creating and managing an asset allocation model;
an asset class manager for at least one of creating and managing at least one asset class within said asset allocation model.

3. The system of claim 1 wherein said entire paragraph is a response dependent field that is at least one of shown and hidden depending on said responses to said plurality of investment policy questions, wherein said hidden paragraph is collapsed.

4. The system of claim 1 wherein said template manager includes a template creation interface, a template management interface, a template sections and paragraphs interface, an edit template section interface, a response-dependency interface and a manage header footer editing interface.

5. The system of claim 1 comprising a compliance moderator for control of template usage, wherein said compliance moderator indicates whether said paragraph of each of said templates is at least one of editable and required.

6. The system of claim 1 wherein said investment policy generator includes a risk assessment module that analyzes at least a subset of said responses to said investment policy questions to produce a risk grade, wherein said risk grade is incorporated into said investment policy statement.

7. The system of claim 1 wherein said template manager comprises a code segment, stored on a physical computer readable memory, wherein said questionnaire manager comprises a code segment stored on a physical computer readable memory, wherein said investment policy statement generator comprises a code segment stored on a physical computer readable memory.

8. A method for creating an investment policy statement for a client comprising:
receiving an investment policy statement template selection including a plurality of paragraphs relating to at least one of investment objectives, time horizon, tax policy, risk tolerance, asset allocation, advisor philosophy, diversification and investment constraints, wherein at least one of said plurality of paragraphs in includes a response dependent field;
communicating an investment policy statement questionnaire including a plurality of questions relating to at least one of said paragraphs, wherein said investment policy statement questionnaire is tailored to said investment policy statement template selection;
receiving a plurality of responses to said questions of said investment policy statement questionnaire;
generating an investment policy statement, wherein said response dependent fields are completed at least partially based on said responses to said questions of said investment policy statement questionnaire, wherein said investment policy statement includes at least one of an investment objectives paragraph, a time horizon paragraph, a tax policy paragraph, a risk tolerance paragraph, an asset allocation paragraph, an advisor philosophy paragraph, diversification paragraph and an investment constraints paragraph.

9. The method of claim 8 wherein at least an entire one of said plurality of paragraphs is a response dependent field that may be shown or hidden depending on said responses to said investment policy statement questionnaire.

10. The method of claim 8 comprising receiving revisions to said investment policy statement.

11. The method of claim 8 comprising indicating whether each of said paragraphs of said investment policy statement template is editable, required, or both.

12. The method of claim 8 comprising assessing risk, wherein said assessing of risk includes analyzing at least a subset of said responses to said investment policy questions to produce a risk grade, and incorporating said risk grade into said investment policy statement.

13. The method of claim 8 further comprising receiving an asset allocation model selection and incorporating said asset allocation selection into said investment policy statement.

14. A data model for supporting the creation of an investment policy statement comprising:
an investment policy statement instance entity including
an investment policy statement template entity that indicates the investment policy statement template used for the investment policy statement and parameters associated with the investment policy statement;
an investment policy statement instance text entity that define sections and paragraphs for said investment policy statement; and
an asset allocation model entity that includes a data representation of an asset allocation model.

15. The data model of claim 14 further comprising a header footer entity that includes header footer data associated with the investment policy statement.

16. The data model of claim 14 further comprising an investment policy statement instance status entity that indicates whether or not the investment statement policy is complete.

17. The data model of claim 14 wherein said asset allocation model entity comprises:
an asset allocation model holding entity that maps asset classes to asset allocation models and defines percentage allocations of said asset classes and includes statistical metrics as computed from historical data or supplied by users;
a calculation type entity that defines asset allocation model calculations;
a correlation type entity that defines when the statistics are automatically correlated; and
an account entity that identifies the owner of the investment policy statement and any custom allocation models.

18. The data model of claim 17 wherein said asset allocation model holding entity comprises asset classes with user-defined historical statistics and historical statistics.

19. The data model of claim 14 wherein said questionnaire data model comprises:
a question entity that defines question text and includes a plurality of question part entities that define how a response to said question will be incorporated into said investment policy statement through the inclusion of said question parts in said template section paragraphs;
a question set entity wherein said question set entity comprises individual question entities and question groups for ranking and numbering;
a questionnaire entity that combines question set entities.

20. The data model of claim 19 wherein said question entity further comprises a question part and question part data type, wherein said question part comprises a question part answer entity that includes a user response to said question, wherein said question part data type indicates a data type for said question part.
